(19) United States
(12) Patent Application Publication
(10) Pub. No.: US 2006/0047649 A1
(43) Pub. Date: Mar. 2, 2006

(54) Internet and computer information retrieval and mining with intelligent conceptual filtering, visualization and automation

(76) Inventor: Ping Liang, Irvine, CA (US)

Correspondence Address: Ping Liang, 18 Vienna, Irvine, CA, 92606, US

(21) Appl. No.: 11/263,194

(22) Filed: Oct. 31, 2005

Related U.S. Application Data
(63) Continuation-in-part of application No. 11/024,098, filed on Dec. 28, 2004.
(60) Provisional application No. 60/533,205, filed on Dec. 29, 2003.

(51) Int. Cl. G06F 17/30

(52) U.S. Cl. 707/4

(57) ABSTRACT

The present invention presents embodiments of methods, systems, and computer-readable media for the retrieval, mining, filtering and visualization of information stored on a plural of computers connected to the Internet and on a local computer. Embodiments of this invention generate a conceptual search query using a description provided by a user, perform user selectable conceptual filtering of search results, concept following and link following to expand search results, search for files that may or may not contain certain information, rank concepts contained in search results or one or more files, compute relevancy rank of a file in search results, use conceptual path maps to display logic or statistical relationships among search results, monitor changes in information in a search or a file, and protect files or searches based on information contents.

### RELATED APPLICATIONS

This application claims the benefit of U.S. Provisional Application Ser. No. 60/624,249, filed on Nov. 1, 2004, and is a continuation-in-part of U.S. patent application Ser. Nos. 11/024,098, 11/024,324 and 11/024,325 filed on Dec. 28, 2004 and which claim the benefit of U.S. Provisional Application No. 60/533,205 filed on Dec. 29, 2003. Each of the above related applications is incorporated herein by reference.

### FIELD OF THE INVENTION

The present invention relates to methods and software for information retrieval, mining, filtering and visualization, and more particularly, to methods and software for the retrieval, mining, filtering and visualization of information stored on a plural of computers connected to the Internet and on a local computer.

### BACKGROUND OF THE INVENTION

Main limitations of present day web search methods are listed below:
1. Prior art web search methods often return a huge number of results, e.g., hundreds of thousands or even millions. A user cannot possibly read all these results in a practical amount of time. Most users do not go beyond the first 10 to 30 results. As a result, useful or important information are often not seen by the user. This makes most of the thousands to millions of web pages returned by a search engine useless. It reduces the usefulness the search engines' power to index and search billions of pages. The need to organize such large number of search results has been widely recognized. There are prior art search engines that either use pre-defined categories or tabs or use clustering techniques. Pre-defined categorization of web pages requires a given taxonomy. Clustering techniques such as Clusty.com categorize search results by clustering words it extracts from part of the search results. Since clustering is statistical, it often identifies clusters that are either non-informative or irrelevant. In addition to their deficiencies in extracting the correct and important words and concepts as compared to this invention, prior art clustering techniques are not convenient for filtering search results using user selected multiple categories.
2. Prior art search engines force user to use keywords or word strings to search for information. Sometimes, a user may not know the proper keywords to use. A more desired method is to accept user's natural language description of what he is looking for and use it to formulate a search for the user.
3. Using prior art search methods, a user often must spend hours sitting in front of a computer trying to find the needed information. A user needs to manually click and follow links, reformulate searches using the concepts found from previous searches, and wait for downloads of large files.
4. There is no effective solution available in prior art for users to monitor web sites and search results. A user often needs to perform searches using multiple sets of search keywords repetitively over a period of time to, see if new information appears or if there are changes to previously visited sites.
5. In some prior art, a user needs to perform separate searches of the Internet and his computer to find relevant information in both. In some prior art solutions that offer indexed search of files on a user's computer, a different interface is used for the search of files in a local computer's hard drive than the browser interface used for Internet search. In other prior art solutions that use the same interface for web search and local computer file search, the two searches are tied together. Even when a user only wants to search his files in his computer's hard drive, the search keyword(s) are sent to a web search engine, unnecessarily exposing the user's private activity. In some of these embodiments, a local computer file search cannot be conducted when the computer is not connected to the Internet.
6. When a search engine receives, often records, the search keyword strings used by users, it can reveal a user's intention or invention to the search engine. In such cases, it becomes a privacy or confidentiality concern for some users.

Therefore, from the foregoing, it becomes apparent that there is a need in the art for the development of advanced or intelligent method for information retrieval and mining from the Internet and computer that overcome the above shortcoming.

### SUMMARY OF THE INVENTION

This invention contains advancements in web search, conceptual search, text mining, extraction of characterizing concept from search results, user selectable conceptual filtering of search results, visualization of conceptual clustering and statistical and logic relations, automated deep and expansive search, automated change detection and monitoring, local computer file search, relevancy ranking and concept ranking, split meta search for user privacy. This invention produces advanced intelligent search, information mining, management, visualization and analysis tools. It provides unprecedented capability to users.

This invention provides a badly needed tool that can assist a user to quickly view the important concepts contained in a large number of search results as a summary of the search results. It extracts and ranks important concepts in search results, and calculates their statistics. There may be a large number of concepts, this invention allows a user to select concepts and to filter, rank and sort the search results based on the selected concepts and other characteristics of the search results. It also provides a visualization of the clustering and statistical and logic organization of the search results based on the important concepts, thus allowing a user to quickly gain a better understanding of the information contained in and relations among the large number of search results. It offers a better way for information mining from search results by extracting characterizing important concepts and their statistics from search results. It extracts not only the most frequent concepts, referred to as Most Popular Concepts (MPC), but also important but rare concepts, referred to as Most Original Concepts (MOC). Ranking of concepts can be based on search relevancy, statistics from the search results, link popularity ranking, and rarity. It can rank high both MPCs and MOCs. A user can select or exclude extracted important concepts from a list to filter search results, and can fine tune a search or change direction of a search based on the important concepts extracted from the search results. This invention also shows a graphic visualization of the clustering of the search results based on extracted important concepts and statistical and logical relationships among the extracted concepts in a Concept Path Map (CPM). The CPM provides a user a quick way to visualize and navigate the search results based on the contents and relations in the search results. These are much more flexible and useful tools than the prior art “Refine Search” or clustering methods.

This invention provides a natural language user interface where a user can describe what he wants to search using natural language without knowing the exact keywords to use. This invention will perform natural language processing and automatically formulate searches for the user based on the user's natural language description. This invention broadens a search by expanding search keywords into concepts comprising of the synsets, hypemym, and/or hyponym/troponym of a keyword, and acronyms or full expressions of a concept, and uses mutual reinforcement between the senses of two or more keywords to disambiguate the proper senses from multiple senses of search keywords.

This invention automate much of the search process by automatically following links, reformulating searches using the concepts found from previous searches to deepen a search using keywords. It also can automate downloading of large files in the search results for a user. This way, a user no longer needs to sit in front of a computer for hours to manually click links to follow a search path and to wait for download of large files. Instead, the search is automated and can be done either in the background so that the user can work on something else or walk away from the computer to do other tasks.

This invention provides an integrated interface that allows a user to search the Internet and his computer's hard drive(s) to find relevant information using the same familiar browser interface, but with user control for the privacy and security of searches of his PC. A search for information in a user's PC here means a search of files in hard drive(s) in a user's computer or in a computer on a local network, including email files such as Microsoft Outlook, Outlook Express, Eudora, and applications files such as Microsoft Word, Excel, Power Point, Adobe pdf, text, Word Perfect, html, and other files that contain texts or textual descriptions including file names and properties.

This invention provides effective automated methods for a user to monitor selected web sites and to monitor new results for one or more searches without having to manually perform the search or browsing repetitively over a period of time.

This invention also provides a method for a user to perform a search without revealing all keywords used for the search to any single search engine. This way, no search engine receives the full list of keywords a user is searching, thus, avoids a search engine from guessing the user's creative intentions or invading a user's privacy. It protects the privacy or confidentiality of a user's intention.

### BRIEF DESCRIPTION OF THE DRAWINGS

FIG. 1 shows a user interface for an intelligent search engine that accepts a user's natural language description of a search and search automation options;

FIG. 2 shows an embodiment of the query generator;

FIG. 3 shows a user interface for an intelligent search engine that accepts search keywords with keyword-to-concept expansion, “Maybe” and search automation options;

FIG. 4 shows a user interface for listing, filtering and visualizing search results;

FIG. 5 shows an embodiment of the intelligent search of this invention that embeds a function interface of this invention into a tool bar of a web search engine interface;

FIG. 6 shows a user interface for listing, filtering and visualizing search results for an embodiment that uses the interface in FIG. 5 to perform a search;

FIG. 7 shows a user interface that uses a separate window for listing, filtering and visualizing search results from searching hard drive(s) in a local computer;

FIG. 8 shows examples of concept path maps, 8(a) an MPP CPM, 8(b) an MOP CPM, and 8(c) an alternative form of an MPP CPM;

FIG. 9 shows an example of an MPP CPM in a user interface window, where a node that includes web pages or files containing the important concepts selected in 912 is highlighted;

FIG. 10 shows the functional block diagram of index files or databases used in an embodiment of this invention;

FIG. 11 shows an adjustable 3-bar interface for a user to adjust the weight of each ranking term;

FIG. 12 shows an improved search interface for a search of local computer hard drive(s) incorporating new features of this invention;

FIG. 13 shows a high level flow chart of some of the embodiments of this invention for a web search.

FIG. 14 is a flowchart illustrating a method of this invention for query generation and conceptual expansion.

FIG. 15 is a flowchart illustrating a method of this invention for searching using information that may or may not be contained in files.

FIG. 16 is a flowchart illustrating a method of this invention for extracting concepts or other information elements from one or more files, filtering of search results using concepts or other information elements, search results expansion using concept following and link following.

FIG. 17 is a flowchart illustrating a method of this invention for ranking concepts or other information elements extracted from one or more files.

FIG. 18 is a flowchart illustrating a method of this invention for organizing a set of files into a concept path map based logic, semantic or statistical relationships.

FIG. 19 is a flowchart illustrating a method of this invention for computing a relevancy rank of a file in search results.

FIG. 20 is a flowchart illustrating a method of this invention for monitoring changes in information contained in a file or in a search.

FIG. 21 is a flowchart illustrating a method of this invention for information protection based on the contents of a file or a search.

### DETAILED DESCRIPTION OF THE PRESENT INVENTION

Reference will now be made to the drawings wherein like numerals refer to like parts throughout. Exemplary embodiments of the invention will now be described. The exemplary embodiments are provided to illustrate aspects of the invention and should not be construed as limiting the scope of the invention. When the exemplary embodiments are described with reference to block diagrams or flowcharts, each block represents both a method step and an apparatus element for performing the method step. Depending upon the implementation, the corresponding apparatus element may be configured in hardware, software, firmware or combinations thereof. Some terms are defined below.

Concept: When used in this invention in the context of expanding a first word or phrase to its meaning, the word concept means the set of words or phrases that have the same or similar meaning with the first keyword or phrase. The set may include synonyms and hypemyms and/or hyponyms/troponyms of a word. In this invention, some times the term concept is used interchangeably with the term keyword or search keyword or search keyword string. In such cases, it means that the keyword or search keyword or search keyword string is a representative of a concept. When used in this invention in the context of extracting words or meanings that characterizes a file or web page or search results or are considered important in a file or search results by a rule or criterion, the word concept or interchangeably in this context with the term “important concept,” means one or more words or a strings of words or phrases that are extracted from a web page or file according to one or more of rules or criteria. It may also be expanded to a set of words or phrases that have the same or similar meaning.

File: A file in the context of a web search means a web page or any file found using a search engine. A file in the context of a search or information retrieval from a computer's hard drive or stored in a local network means any file residing in a computer's hard drive or stored in a local network. Examples of a file include but are not limited to any object with textual contents, a word processing file (e.g., Microsoft Word, WordPerfect), a spreadsheet file (e.g., Microsoft Excel), an Adobe PDF, notepad, Microsoft PowerPoint, TXT, XML or HTML file, an email, a media file (audio, music, picture video) with textual annotations or file information such as title, author, summary etc., an item in a database, a computer program.

Hard drive search: Search of files in one or more hard drives in a user's PC or in a computer in a user's local network.

Keyword, phrase: When the term keyword or phrase is used alone, it means the word or string of words provided by a user to describe what he wants to search for.

Search keyword, query keyword, search keyword string, query keyword string, search phrase, query phrase: The keyword or string of keywords that is actually used to perform a search. It may be generated from, but may be different from, a keyword or phrase provided by a user. In some cases, they are generated by the Query Generator (QG) of this invention.

Sense: The meaning of a word or phrase. A word or phrase may have multiple senses.

Synset: The set of synonyms of a sense of a word.

A word string inside quotation marks is used for exact matches in a search. For convenience, a keyword or description used to define a search or any information about or contained in a file, e.g., a word; a word string; a phrase; a sentence; a sentence pattern; a concept; a statement; a link; the URL, file type, date, title or author of a file, etc., is referred to as an information element.

### Intelligent Query Generator and Keyword to Concept Expansion

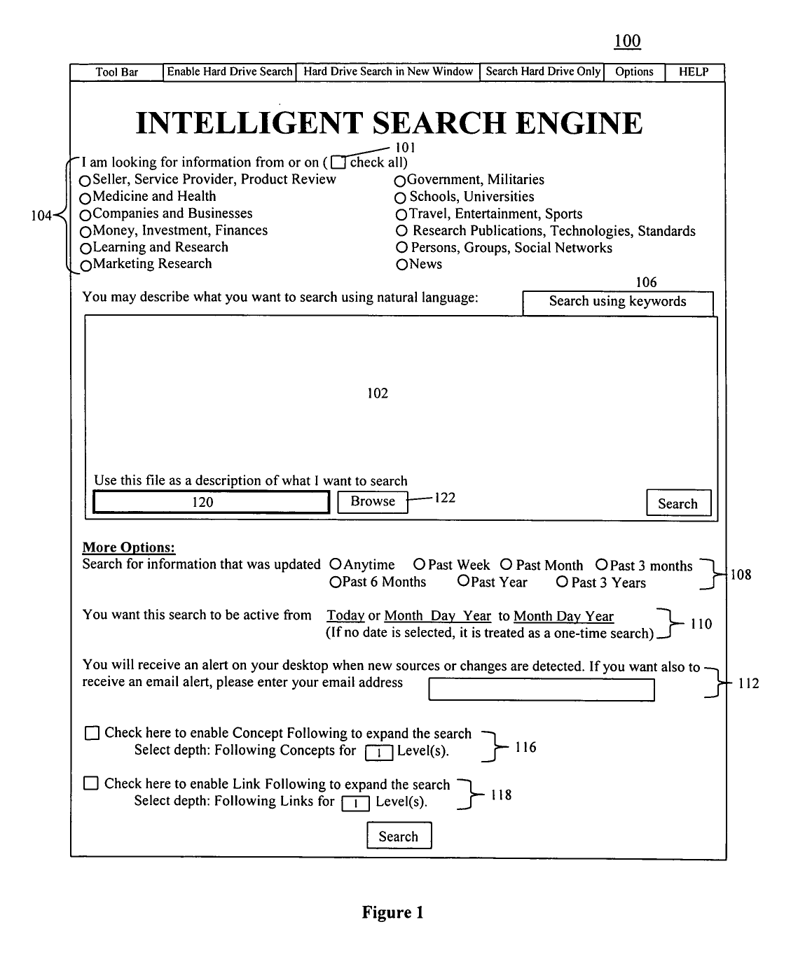

Instead of forcing users to use a string of keywords to do the search, this invention provide users with a Natural Language Interface (NLI) 100 as shown in FIG. 1. In one embodiment, in the box 102 a user may enter a Natural Language Description of his Search (NLDS), or enter keyword strings as in traditional search engines, or a combination of keyword strings and natural language description.

In one embodiment, at the top of the NLI, there is a User Intentions List (UIL) 104 for a user to specify the intention of his search. In one embodiment, the “check all” box 101 is checked by default, thus allowing searching and returning everything found. A user can skip and not use the UIL 104. The user's intention can be extracted from the NLDS in 102. There is also a button 106 to select searching by entering keyword strings.

A Query Generator (QG) that runs on the user's local computer extract words or word strings from the NLDS and submits the extracted words or word strings as search keywords or search keyword strings to a search engine or uses the extracted words or word strings as search keywords or search keyword strings to perform a search. Personalization of the search is achieved both by the user's description of the search and the UIL if used, and by the user's preference or search history stored on the user's local computer. This personalization protects the user's privacy because the user's search history or preference is stored in the user's local computer, not the search engine.

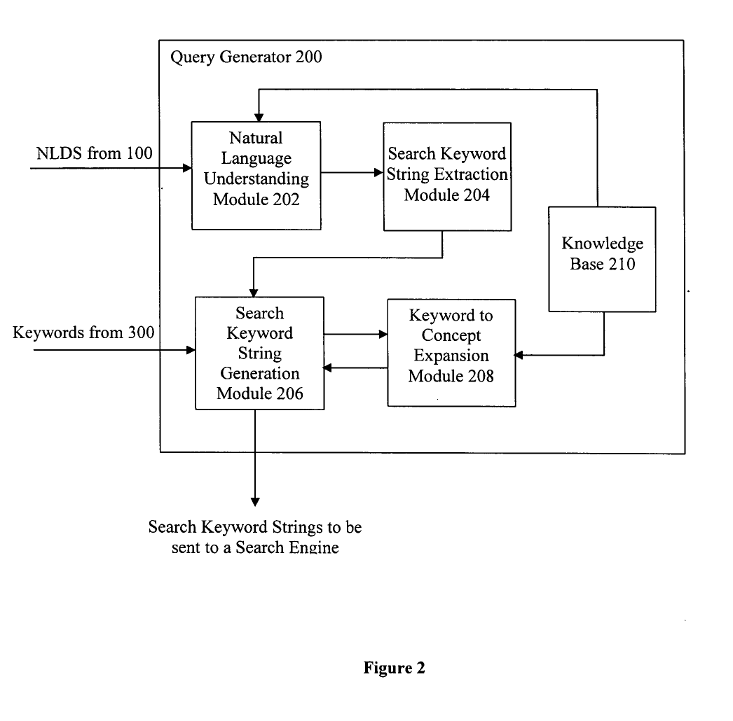

In addition to directly extract search keyword strings from the user's description of his search, the QG also includes a natural language understanding module 202, a keyword to concept expansion module 208 and a knowledge base 210 that are installed on the user's local computer to interpret and translate a user's natural language description into relevant keywords and expand keywords into concepts, as shown in FIG. 2. For example, when a user enters into the natural language description that “I am looking for a device that will be able to connect all my computers wirelessly to the Internet”, then the natural language understanding module 202 using the knowledge base 210 that contains knowledge about wireless networking will translate the user's description into the keyword strings of (wireless router), (wireless access point), (WLAN router), (wireless broadband router), etc. As another example, when a user enters into the natural language description that “I want to buy a wireless router that connects all my computers wirelessly to the Internet”, then, using the knowledge base 210 that contains knowledge about wireless networking, the search keyword string extraction module 204 will extract the keyword strings (wireless router), (connect computer wirelessly Internet), and the natural language understanding module 202 and the keyword to concept expansion module 208 will interpret the user's search intention as (to buy), (to purchase), and expand the extracted keyword strings to (wireless router), (wireless access point), (WLAN router), (wireless broadband router), (802.11 router), (home networking), etc.

The NLI 100 also offers a user more options to filter his search, including range of modification dates 108, the option to keep his search active for a period of time to monitor for new sources and changes to existing sources by specifying a date range in 110, and when a change is detected, the option to alert the user on his local PC or send an email to an email account that the user provides in 112. Other options include concept following 116 and link following 118 in searching to expand the range of search based on the search results of the initial search. These features will be discussed in detail later sections of this invention.

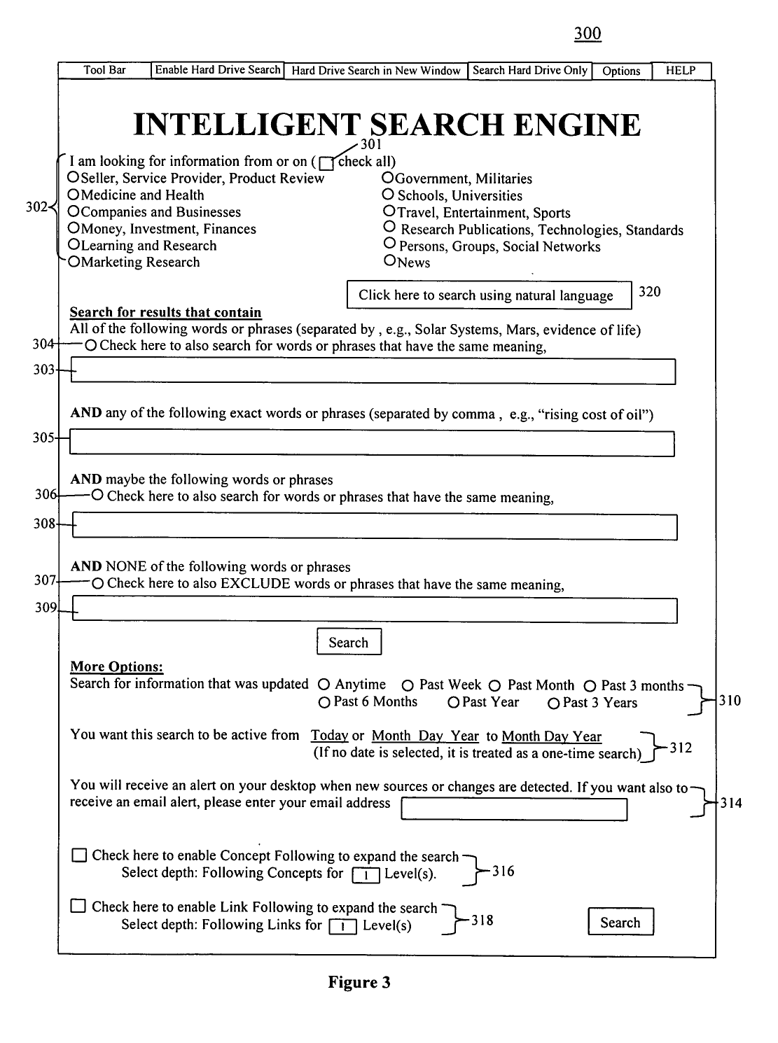

In one embodiment, if a user clicks button 106, an alternate Keyword User Interface (KUI) 300 as shown in FIG. 3 is provided. The KUI 300 differs from prior art search engine interface in that the KUI 300 contains a UIL 302, a keyword to concept expansion option (buttons 304 and 306), a “maybe” section 308, date range filter 310, keep search alive date range 312 and email notification option 314. The keyword strings entered by a user in KUI 300 are sent to the Search Keyword String Generation Module 206 in QG 200. If buttons 304 and/or 306 are checked, the QG 200 uses the Keyword to Concept Expansion Module 208 to expand the keywords strings entered by the user into concepts. Then, based on the keyword strings entered by the user and the keyword to concept expansion results, the Search Keyword String Generation Module in QG 200 generates search keyword strings to be used to perform the search, or to be submitted to a search engine. The default of the UIL 302 can be “Check All” with all intentions in the UIL checked, thus this embodiment may search and return everything found. The UIL may be omitted in another embodiment. This embodiment may provide a button 320 for a user to select the NLDS interface 100 to perform search.

In one embodiment, the keyword strings extracted and/or generated by the natural language understanding module 202 and the search keyword string extraction module 204 are sent to the keyword to concept expansion module 208 which, working in conjunction with the knowledge base 210, expands the keywords strings to include words and phrases with same or similar meanings, thus ensuring the retrieval of web pages and files that contain information a user is looking for but is described using different words or phrases. Similar to prior art search engines, certain common words are not included in search keywords, such as (of, with, the, etc.), unless a user enclose these words in a sentence with quotation marks, or they are the only words.

In all above embodiments, the extraction of keyword strings and translating of user's natural language description into relevant keyword strings are done on the user's local computer. In alternate embodiments, these functions are implemented in the search engine. The advantage of doing so is that the keyword string extraction module 204, the natural language understanding module 202 and the knowledge base 210 can be maintained and updated at a centralized machine. The user's local computer submits the user's natural language description of the search directly to the search engine. The disadvantage of implementing these functions on the search engine is that it may create heavy processing loads on the search engine. In yet another alternate embodiment, some of these functions are implemented on the local machine using the processing powers of the large number of local computers, and some of these functions are implemented on the search engine to further process or enhance the extraction and translation results of the local computers using the up to date keyword string extraction methods, the natural language understanding methods and the knowledge base maintained in the search engine.

In one embodiment, when a user's computer is connected to the Internet or when a user visits a search engine or a server, it communicates with a server which can provide updates to the components of the QG, namely, the search keyword string extraction module 204, the keyword to concept expansion module 208, the natural language understanding module 202 and the knowledge base 210 installed on a user's local computer to keep them up to date. Such updating can be performed each time the local computer is connected to the Internet, or each time the user visits a search engine or server, or it can be performed on a periodic basis.

### Extract Search Keyword Strings and Search Intention

Extraction Search Keyword Strings and Search Intention from NLDS

In cases where the search keywords are contained in the NLDS, this invention identifies and extracts such search keywords embedded in the NLDS. In one embodiment, this is achieved by using of known sentence patterns and clue words. Each language, e.g., English, Chinese, French, German, has certain sentence patterns and clue words that are used with high probability in describing a search.

In one embodiment, the Search Keyword String Extraction Module 204 scans the NLDS for the following characterizations of a search: Intention, Search Keywords, Maybe Words, Date Range, Sources, Type of Pages, and Exclusion.

In an NLDS, it is highly likely that the subject and/or intention of a search are given in one or more sentences similar to one of the following examples of sentence patterns:

| | |
|---|---|
| I am looking for information on . . . | Search for information on . . . |

I want to find (or write, understand, learn, investigate, research, study,
etc.) . . .

| | |
|---|---|
| My search is for . . . | I would like to find . . . |
| I am searching . . . because . . . | I am interested in . . . |

My goal (or objective, purpose, intention, etc.) is to . . .
The goal (or objective, purpose, intention, etc.) of this search is . . .
. . . is (or are, will be etc) the focus (or goal, purpose etc.) of the search.

| | |
|---|---|
| . . . are what I am looking for. | etc. |

In these examples, the subject of the search or search keywords are contained in sentence patterns illustrated above, typically in the “ . . . ” part of the sentence patterns shown above. Thus, the subject or search keywords and/or intention of the search can be extracted from such sentence patterns. This invention may build a database or list of such sentence patterns that can be used to identify these sentence patterns. Natural language understanding algorithms such as those in the state of the art in the field of natural language processing or understanding and artificial intelligence can be applied to extract subject or search keywords and/or intention of the search from such sentence patterns.

There are also sentence patterns from which a program can conclude that a user is looking for any or all information on a subject, for example,

| | |
|---|---|
| I am looking for any information . . . | Search for all information . . . |
| Find anything that is related to . . . | etc. |

A user may also type search keywords alone in the NLDS just like in a prior art search engine interface, for example, (wireless networks, home networking). These are noun phrases without a complete sentence structure and are easy to identify using natural language understanding algorithms such as part-of-speech analysis, word type analysis, and sentence structure analysis. These algorithms can be applied to identify and extract such standalone search keywords.

The intention of a search can be identified as purchasing also by certain clue words or phrases, e.g., cheap, cheaper, cheapest, low (or lower, lowest) price (or cost, payment), buy, purchase, etc. These clue words or phrases indicate a high probability that the user is looking for information to make purchasing decision. Thus, web sites of retailers and product reviews related to the search subject keyword should be ranked higher in the listing of search results. This method also includes handling of exceptions. For example, the word buy in “buy or make”, or “buy vs. make” is a phrase that indicates a search to make a decision on whether to purchase something or make something by oneself, and most likely is looking competitive and marketing information, rather than indication of a search for retailers and products to make a purchase. This invention builds a database or list of such clue words and phrases and exceptions that can be used for extraction of intention of the search.

This invention may also build databases or lists of sentence patterns, clue words and phrases and exceptions that can be used for extraction of other fields characterizing or filtering a search, including Maybe, Date Range, Sources, Type of Pages, and Exclusion.

In an NLDS, it is highly likely that the “Maybe Words” of a search is given in one of the following sentence patterns:

| They may contain . . . | These words are likely . . . |
|---|---|
| It is possible that the following words are used . . . | |
| They should include . . . | . . . may also be included. |
| Maybe: . . . | etc. |

“Maybe Words” can also be identified in sentences that contain words in a “Maybe” List, which includes words like (likely, may, should, could, might, probably, possibly . . . ). This embodiment may conduct searches without, with some and with all “Maybe Words.” It may rank search results that contain more “Maybe Words” higher than those with less or without.

In an NLDS, it is highly likely that the Date Range of a search is specified in one of the following sentence patterns:
The pages should be modified (or created, written etc.) recently . . .
Return results modified or created in the last . . .
Date range: . . . etc.

In an NLDS, it is highly likely that the Sources of a search are specified in one of the following sentence patterns:
I am interested in universities (or manufactures, companies, non-profit, etc) . . .
Only search for English (or Australian, Chinese etc.) sites . . .
Return results from .edu . . . etc.

In an NLDS, it is highly likely that the Types of Pages of a search are specified in one of the following sentence patterns:
Only search for html (or Word, pdf, etc.) pages . . .
Return results in Word (or pdf, html, etc.) . . .

In an NLDS, it is highly likely that the Exclusions of a search are specified in one of the following sentence patterns:

| | |
|---|---|
| I don't want . . . | Do not search for . . . |
| No . . . | etc. |

This embodiment may eliminate web pages or files that contain keywords identified as Exclusions from the search results.

This invention may build databases or lists of such sentence patterns that can be used to identify these sentence patterns containing the various characterizations of a search. Natural language understanding algorithms such as those in the state of the art in the field of natural language processing or understanding and artificial intelligence can be applied to extract these characterizations of the search from such sentence patterns.

This invention uses a Search Word Extraction Exclusion List (SWEEL) to exclude commonly used words that most likely are not useful to retrieve specific information. Words in this list are not extracted as search keywords. The SWEEL may include words like (be, is, am, are, were, the, a, in, of, on, through, via, to, we, them, he, she, they, it, very, much, too, many, etc.).

OR relationship among keywords can be identified from the NLDS by natural language understanding. Unless a keyword is identified as an OR or Maybe Word, it is treated as a keyword with an AND relationship with other keywords. This embodiment may perform searches with the extracted (and conceptually expanded as shown in the next section) keywords ANDed or ORed as so identified, and the Maybe Words included and not included.

In another embodiment, the NLDS is not entered into box 102; instead, it is given in a text file such as a .doc .rtf, .pdf or .txt file in the computer. This invention provides an option for a user to specify a file as the NLDS to generate search keywords and perform the search. This is done by a user entering the file's path and name into box 120, or browsing for the file using button 122. The program then loads the content of the specified file and uses it as the NLDS.

This invention can also extract search keyword strings from general descriptive and example sentences or texts not specifically written as an NLDS. For example, a user may enter into 102 or a file in 120: “A wireless security agent uses an authentication server to manage user authentication.” Natural language understanding module 202 can analyze this sentence and extract the search keyword strings such as (wireless security), (security agent), (authentication), (authentication server), (user authentication), and can use them to conduct searches. On a higher level, the natural language understanding module 202 can extract both the keywords and the predicate structure of the sentence, e.g., the subject (wireless security agent), verb (uses), direct object (authentication server), and adverb clause (manager user authentication), which can be further decomposed as verb and object. In this example, this embodiment may conduct a coarse search using the extracted search keyword strings first. Then, it can further refine the results from the coarse search by finding web pages or files that contain similar or synonymic subjects, verbs, direct objects and adverb clauses in similar logic relations as the general descriptive and example sentences or texts above.

In some cases, a user does not know the proper names to use to describe what he wants to search. Thus, he may use descriptive languages to describe the features, characteristics or functions of what he is looking for. An example of this is described earlier where a user enters as the NLDS “I am look for a device that will be able to connect all my computers wirelessly to the Internet.” In such cases, the natural language understanding module can use the knowledge base 210 to map the user's descriptions to potential professional vocabularies and generate search keyword strings accordingly. In specialty fields, such as medicine, technology, geology, etc., ontologies for such fields, such as these in the state of the arts, can be built and included in the knowledge base 210.

Extract Search Keyword Strings from KUI

For users who are used to prior art search engines using keyword strings, this invention provides a KUI 300 that is more useful than prior art search engines. A button 320 is provided for a user to select the NLI 100 to use NLDS to perform search. The KUI 300 differs from prior art search engines in several functions:
The KUI 300 contains a UIL 302 for a user to specify his intention for search, for example, to purchase a product, to find educational material, to research markets, etc. Rather than personalization approaches trying to guess what a user's intention, the KUI 300 allows a user to specify his intention explicitly so that the right information is presented to him. A user can skip this step by checking “check all” in box 301. In one embodiment, this box is checked by default. The UIL may be omitted in another embodiment.
This invention offers a user the option to expand the keywords and phrases he enters into concepts by checking buttons 304 and/or 306. The keyword to concept expansion module 208, working in conjunction with the knowledge base 210, expands keywords and phrases to include words and phrases with same or similar meanings, thus ensuring the retrieval of web pages and files that contain information a user is looking for but is described using different words or phrases.
The KUI 300 includes a “Maybe” section 308 that allows a user to enter words or phrases that he is not sure whether they are present in the web pages or files he is looking for. No prior art search engines offer this ability.
Similar to the NLI 100, the KUI 300 also offers date range filter 310, an option 312 to keep a search alive for period of time to monitor for new sources and changes, email notification option 314, concept following option 316, and link following option 318 to be discussed in detail later in this invention.

The keyword strings entered by a user in boxes 303, 305, 206 and 309 are sent to the search keyword string generation module 206 in QG 200. If buttons 304 and/or 306 are checked, the QG 200 uses the keyword to concept expansion module 208 to expand the keywords strings entered by the user into concepts, i.e., to include words and phrases with same or similar meanings. Then, based on the keyword strings entered by the user and the keyword to concept expansion results, the search keyword string generation module 206 in QG 200 generates search keyword strings to be used to perform the search, or to be submitted to a search engine.

Examples of what to be entered into the different fields can be provided to help a user enter his search, as shown below.
Box 303: solar system, Mars, evidence of life Box: 308: Red Planet, rover
Box 305: I believe there is life on Mars, hot Mars Box 309: Martians, space alien

The embodiments of searching for “Maybe” words or phrases provides a new method for searching information, comprising, as shown in FIG. 15, providing an interface to accept from a user a first description and a second description that define a search (1502); searching for one or more files or similar information containing objects that contain some or all of the information in the first description, and contain none or some or all of the information in the second description (1504). In this method, the first description may be one or more keywords, and the second description may be one or more keywords. The second description contains the “Maybe” words or phrases, and may be expanded to “Maybe” concepts or other information elements such as links, file types, etc. This method may also rank higher a file or an information containing object that contains more of the information in the “Maybe” information in the second description.

### Keyword to Concept Expansion

This invention provides two methods to expand keywords to concepts as described below.

Conceptual Expansion using Relational Dictionary Domain Ontology and Knowledge Base

The steps of one embodiment are given below and illustrated using the example that a user enters keywords (rising cost of oil). We may use the online dictionary WordNet as an example for a relational dictionary that provides senses and synsets of a word, and shows the hierarchical conceptual relationships among related words by links to hypemyms, hyponyms, troponyms etc.
1. Retrieve the root word and all word forms of the keywords entered by a user, remove very common words and connective words like (of, in, at, on, and, is, with etc.), and generate the expanded keyword list from user entered keywords, e.g., the root word for rising is rise, and the expanded keyword list is ((rising, rise, rose, risen, rises), cost, (oil, oiled, oiling, oils)).
2. If there is only one sense for a first keyword, choose this sense and enter the synset of the sense of the first keyword into the Query Set (QS) of the first keyword.
3. If a first keyword has more than one sense, compare each of the first keyword's senses and descriptions to each of the senses and descriptions of each of the remaining keywords. If there is a second keyword that has a second sense that uses a same word in its synset as in the synset of the first sense of the first keyword, or has descriptions that are similar in meaning to the description of the first sense of the first keyword, the first sense of the first keyword is chosen and its synset is added into the QS of the first keyword. The second sense of the second keyword is also chosen and its synset is added into the QS of the second keyword. This is called Mutual Reinforcement (MR) or Cross Validation (CV). The keywords (rising, cost) are used as an example. Below are WordNet results for rising and cost.

The noun rise has 10 senses (first 6 from tagged texts)
1. (9) rise—(a growth in strength or number or importance)
2. (3) rise, ascent, ascension, ascending—(the act of changing location in an upward direction)
3. (1) ascent, acclivity, rise, raise, climb, upgrade—(an upward slope or grade (as in a road); “the car couldn't make it up the rise”)
4. (1) rise, rising, ascent, ascension—(a movement upward; “they cheered the rise of the hot-air balloon”)
5. (1) raise, rise, wage hike, hike, wage increase, salary increase—(the amount a salary is increased; “he got a 3% raise”; “he got a wage hike”)
6. (1) upgrade, rise, rising slope—(the property possessed by a slope or surface that rises)
7. lift, rise—(a wave that lifts the surface of the water or ground)
8. emanation, rise, procession—((theology) the origination of the Holy Spirit at Pentecost; “the emanation of the Holy Spirit”; “the rising of the Holy Ghost”; “the doctrine of the procession of the Holy Spirit from the Father and the Son”)
9. rise, boost, hike, cost increase—(an increase in cost; “they asked for a 10% rise in rates”)
10. advance, rise—(increase in price or value; “the news caused a general advance on the stock market”)
The verb rise has 17 senses (first 16 from tagged texts)
   1. (30) rise, lift, arise, move up, go up, come up, uprise—(move upward; “The fog lifted”; “The smoke arose from the forest fire”; “The mist uprose from the meadows”)
   2. (23) rise, go up, climb—(increase in value or to a higher point; “prices climbed steeply”; “the value of our house rose sharply last year”)
   3. (20) arise, rise, uprise, get up, stand up—(rise to one's feet; “The audience got up and applauded”)
   4. (8) rise, lift, rear—(rise up; “The building rose before them”)
   5. (5) surface, come up, rise up, rise—(come to the surface)
The noun cost has 3 senses (first 3 from tagged texts)
   1. (379) cost—(the total spent for goods or services including money and time and labor)
   2. (53) monetary value, price, cost—(the property of having material worth (often indicated by the amount of money something would bring if sold); “the fluctuating monetary value of gold and silver”; “he puts a high price on his services”; “he couldn't calculate the cost of the collection”)
   3. (17) price, cost, toll—(value measured by what must be given or done or undergone to obtain something; “the cost in human life was enormous”; “the price of success is hard work”; “what price glory?”)

The above procedure will choose Sense 9 of the noun rise, Sense 2 of the verb rise and Senses 2 and 3 of the noun cost because they all contain the word value or cost, or are related to the concept value or cost. Thus, the QS of (rise, rising, rose, risen) now consists (rise, boost, hike, cost increase, rising, rose, risen, go up, went up, gone up, going up, goes up, climb, climbed, climbing, climbs), and the QS of (cost) now consists (cost, price, monetary value, toll).

If there is no mutual reinforcement for selecting a sense from the many senses of a keyword, then synsets of the first 1 to 3 or all senses of the keyword are added into the QS for the keyword. In one embodiment, the number of senses to be added to the QS depends on the usage frequency of the sense or their usage in tagged documents (as provided by an electronic dictionary such as WordNet, as shown inside the ( ) following the sense numbers in the above examples), and senses with low usage frequencies are cut off.
4. Repeat the above for all keywords.
5. Add the synsets of the hypernyms and hyponyms or troponyms of the chosen senses of each keyword to its QS. In doing so, the method may go up one level in the hypemym hierarchy. It may also go up two levels. In one embodiment, synsets of hypemyms at the first level up is used, and synsets of hypemyms at the second level up is used if the synsets or its descriptions include a significant portion that uses the same words or words from the synsets of the first level up or the keyword itself, e.g., more than 50% or more than two words. We illustrate this step using the root word keyword (rise) as an example. Sense 2 of (rise) and its hypemyms as given by WordNet are:
   Sense 2
   rise, go up, climb—(increase in value or to a higher point; “prices climbed steeply”; “the value of our house rose sharply last year”)=
      =>grow—(become larger, greater, or bigger; expand or gain; “The problem grew too large for me”; “Her business grew fast”)=
         =>increase—(become bigger or greater in amount; “The amount of work increased”)=
            =>change magnitude—(change in size or magnitude)

The first level hypernym up is (grow); second level up is (increase). The description of both the first level and second level hypernyms contain (become, bigger, greater), so synsets from both levels (grow, increase) are added to the QS of the keyword (rising). To simplify processing, one may choose to use only the first level hypernym, in this example only (grow) will be added.

The method may go down one level for the hyponyms or troponyms. For both the hypernyms and hyponyms/troponyms, only words or word strings that are different or do not contain words from the synsets of the keyword are already in the QS are added to the QS. Use Sense 1 of the keyword root word (oil) as an example, it has hyponyms (fuel oil, lubricating oil, crude oil, crude, petroleum etc.). Only (crude, petroleum) are added into the QS of (oil) from its hyponym because (fuel oil, lubricating oil, crude oil) already contain the keyword (oil) and documents containing (fuel oil, lubricating oil, crude oil) will be retrieved by a match of the keyword (oil). On the other hand, no match will be found for keyword search of (oil) in a document containing (crude, petroleum). Thus, (crude, petroleum) are added into the QS of the keyword (oil).

If a first sense of a first keyword is selected because of MR by a second sense of a second keyword, and a third sense of the first keyword has a hyponym/troponym that share synset words with the first sense's synset or hyponym or troponym, the synset of the third sense and the synsets of the third sense's hyponym/troponym that share synset words with the first sense are also added to the QS of the first keyword.

In one embodiment, the hypernym and hyponym/troponym expansion is applied only to noun and verb senses. It can also be applied to adjective and adverb senses.

Using the QS of all the keywords, the search keyword string generation module 206 then generates the keyword strings to be used for search. The search keyword string generation module 206 uses OR relation between words expanded from each keyword and can use various combinations of AND relation among the keywords entered by the user. In the (rising cost of oil) example, the search keyword string generation module 206 can generate the following searches:
(rise OR boost OR hike OR “cost increase” OR “go up” OR climb OR grow OR increase) AND
   (cost OR price OR value OR toll) AND (oil OR crude OR petroleum)
      Note that the different forms of each word, e.g., rise, rising, rose, etc., are not included in the above example. They can be included. The matching of different forms of a word to its root word can be handled either at the search algorithms or at the query generation algorithms. The embodiments of this invention can be structured to interface to either approach.

If a user entered the search description or keywords using the NLI 100, if a decision cannot be made as to whether the user wants the relations between the extracted or generated keywords to be AND or OR, the QG 200 can use various combinations to perform the search, and rank search results based on the number of keywords joined by AND. Search results that contain all keywords joined by AND are ranked the highest. For example, the QG 200 can generate additional searches for (rise OR boost OR . . . ) AND (cost OR price OR value OR toll), and (cost OR price OR value OR toll) AND (oil OR crude OR petroleum). However, the search results for (rise OR boost OR hike OR “cost increase” OR “go up” OR climb OR grow OR increase) AND (cost OR price OR value OR toll) AND (oil OR crude OR petroleum) will be ranked the highest.

The natural language understanding module 202 can use part-of-speech and word type and role analysis algorithms to analyze whether the keyword is a noun, verb, adjective, etc. This will limit what senses of a keyword will be selected in the keyword to concept expansion. Some simple rules may be used to make this decision. For example, in (rising cost of oil), the natural language understanding module 202 can use the “of xxx” form to decide that xxx is a noun if it is the only word following (of) before a punctuation mark or end of keyword string. Thus, in this case, (oil) is determined to be a noun. The natural language understanding module 202 can also use the “of a/an/the xxx yyy” or “of xxx yyy” forms to decide that xxx is an adjective and yyy is a noun if they have these senses. The natural language understanding module 202 can use simple linguistic and grammatical rules such as these can be applied to determine the word type of words in a sentence, with a high probability of correctness. The goal is to reduce the amount of processing to be done 100% accuracy is not necessary in this application.

If a decision cannot be made on whether the keyword is a noun, verb, adjective, etc., then the keyword to concept expansion module 208 will use either the noun and verb form of the word or all its forms including adjective and adverb.

Conceptual Expansion Using Search Results

The web pages and files in the search results often contain definitions, conceptual expansions, meanings and descriptions of the keywords used for search. Thus, another embodiment of this invention can resolve ambiguities of a keyword and expand a keyword to a set of conceptually equivalent words by using contextual or co-occurring words in retrieved documents that contain exact matches to the keywords used for the search.

For example, a user enters keywords (QoS) or (WLAN) either in the NLI 100 or the KUI 300. If the knowledge base 210 contains the relevant domain knowledge, they can be expanded to include (QoS, “quality of service”), (WLAN, “wireless LAN”, “wireless local area network”, 802.11, 802.11a, 802.11b, 802.11g, WEP, WPA, . . . ). Searches will be performed using the conceptually expanded keywords. However, if the knowledge base 210 does not contain the relevant domain knowledge, a search using the keyword (QoS) or (WLAN) only may be performed. The search results may highly likely contain definitions of the acronyms which natural language understanding algorithms can easily identify and extract, for example by searching the following sentence patterns,
QoS=Quality of Service . . .
QoS (Quality of Service) . . .
Quality of Service (QoS) . . .
wireless local area network=WLAN . . .
WLAN means wireless LAN . . .
xxx is referred to as (or called, abbreviated as, etc) yyy . . .

Also, in the search results for WLAN, words like 802.11, 802.11a, 802.11b, ^{8020.11}g, WEP, WPA, wireless router, broadband, home networking, etc., will have high occurrences. Thus, this invention can expand keyword searches using search results as its knowledge base, which is likely to be more up to date than a knowledge base maintained by one entity because the web is dynamic, distributed and being updated very quickly. In the above example, using the search results, searches for (QoS) and (WLAN) can be expanded to (QoS, “quality of service”), (WLAN, “wireless LAN”, “wireless local area network”, 802.11, 802.11a, 802.11b, 802.11g, WEP, WPA, wireless router, broadband, home networking, . . . ).

In one embodiment, this invention uses the natural language understanding module 202, the search keyword string extraction module 204 and the search keyword string generation module 206 to analyze search results to find definitions, equivalent concepts, acronyms, and related concepts of search keywords using sentence patterns, contextual, co-occurrence and association analysis. In one embodiment, the QG 200 may expand those keywords that have MR or whose meaning can be decided using natural language understanding module 202, knowledge base 210 and the domain ontologies contained therein. After search results are obtained, natural language understanding algorithms may be applied to the search results to extract words that co-occur with high frequency or high relevancy with the search keywords in the retrieved documents to expand the scope of search. In another embodiment, the QG 200 uses user entered or extracted keywords, without keyword to concept expansion, to perform an initial search, and applies natural language understanding algorithms to the search results to extract words that co-occur with the search keywords in the retrieved documents to expand the scope of search.

Other examples of the results of such embodiments are:
User enters (Software Defined Radio), using the search results of this keyword string, the search is expanded to include searches for (SDR, cognitive radio).
User enters (PSA), using the search results of this keyword string, the search is expanded to include searches for (Prostate-Specific Antigen, prostate cancer, free PSA, fPSA, complex PSA, cPSA, pro PSA, pPSA, biopsy).
User enters (wireless networks), using the search results of this keyword string, the search is expanded to include searches for (WLAN, wireless local area network, 802.11, GSM, 3G, cellular networks . . . )

This type of conceptual expansion is also used in the concept following embodiment of this invention, which will be discussed later.

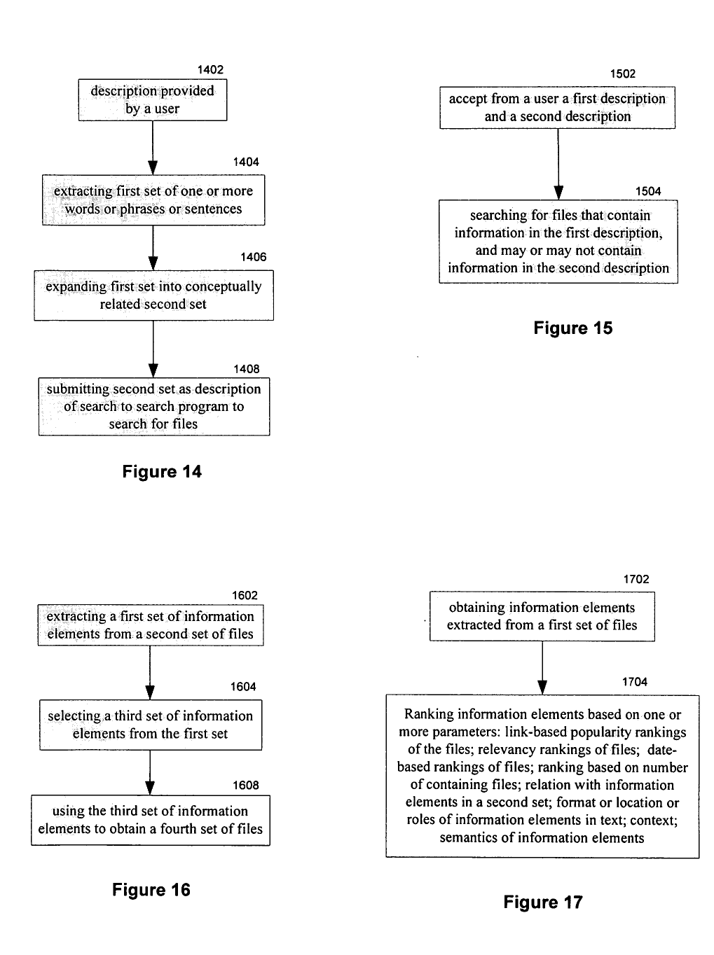

The embodiments of query generation and conceptual expansion provide a new method for generating a search query using a description provided by a user, comprising, as shown in FIG. 14, extracting a first set of one or more words or phrases or sentences from the description (1404); expanding the first set by generating a second set of one or more words or phrases or sentences that are conceptually related to one or more words or phrases or sentences in the first set (1406); and, submitting the second set as the description of a search to a first search program to perform a search for files containing some or all of the words or phrases or sentences in the second set (1408).

In this method, as described in previous sections, the step 1406 may expand the first set using one or more knowledge base for generating the second set, or it may expand the first set one or more search results that are obtained by using the one or more words or phrases or sentences in the first set for generating the second set. Also, when the first set contains two or more words or phrases or sentences, the step 1406 may expand the first set by including in the second set the first set, the synsets of the one or more senses of a word or phrase or sentence in the first set that receives reinforcement from one or more senses of one or more other words or phrases or sentences in the first set, as described in mutual reinforcement. In addition, the first search program (1408) may search for information over a network, or in a user's computer.

### User Selectable Conceptual and Feature Filtering and Concept Path Maps

Conceptual Filtering and Mapping on Search Engine or Local Computer

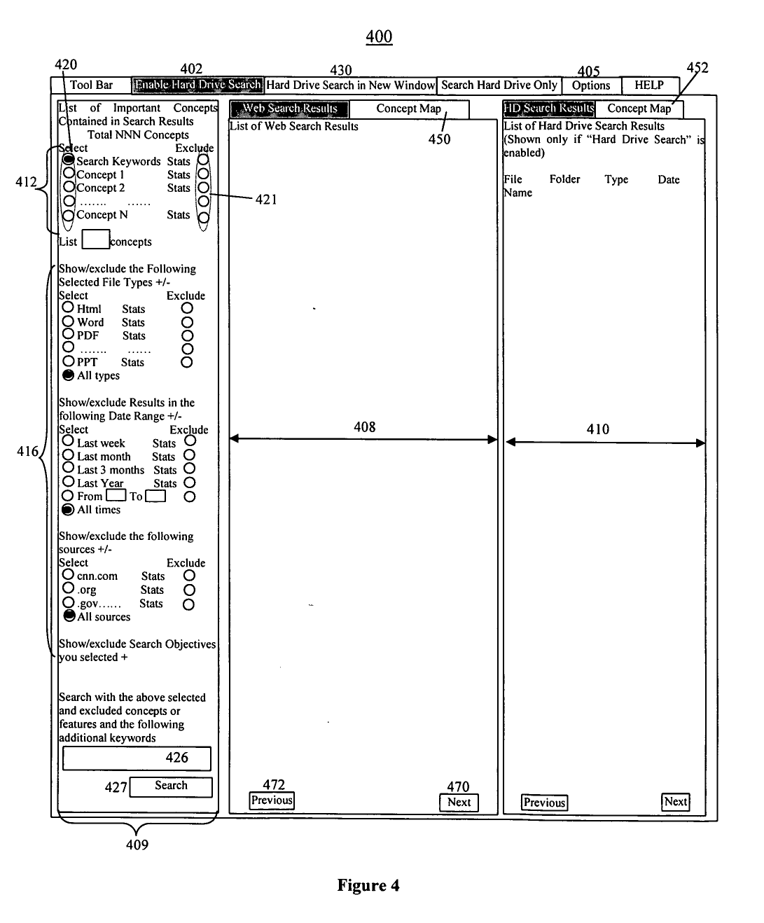

The user interface for conceptual filtering and mapping is shown in FIG. 4. In this embodiment, the concept extraction, filtering and mapping (to be discussed in detail later) are carried out in a search engine embodiment of this invention. A user visits a web site of the said search engine, e.g., as shown in FIGS. 1 and 3. The search results are shown in a browser window format illustrated in FIG. 4. In 400, it is assumed that a user clicked the “Enable Hard Drive Search” option, thus search results from the Internet are shown in the middle pane 408 and search results from the user's local computer are shown in the right pane 410. In this invention, “hard drive” or “hard drive(s) mean the hard drive(s) in a user's PC or in his local network, all referred to as local computer.

In one embodiment, to make it obvious whether a button, e.g., “Enable Hard Drive Search” is selected or enabled, when a button is clicked or selected, it becomes highlighted or changes color or brightness. In addition, a user can adjust the width of each pane 408, 409 and 410 by selecting and dragging the sides of a pane using a mouse.

The top N important concepts, where N is a positive integer and can be set by default or by user, contained in the web pages and files of the search results are listed in left pane 412. N is a number that can be chosen by a user either using the Options button 405 or the input field 406, and N<NNN where NNN is the total number of important concepts contained in the web pages and files of the search results. Note that in one embodiment, the concepts or important concepts above may be keywords or phrases extracted from the search results.

The left pane may have several sections: The first section 412 shows the top N important concepts in the search results. In one embodiment, this important concept list is shown by default and allows a user to select or exclude the listed important concepts and use them to filter the search results. The other sections 416 allow a user to filter the search results by other filtering features such as file types, dates of modification, sources, among other things.

In the section 412, next to each concept is a “Select” check box 420 for selecting a concept and an “Exclude” check box 421 for excluding a concept. When a user checks the “Select” or “Exclude” box of one or more concepts, the search engine of this invention filters the Internet search results and will list in the middle pane 408 only those search results containing both the search keyword strings entered by the user or extracted by the search engine from a user's NLDS and the selected concept(s), and not containing the excluded concept(s). A program installed on the user's local computer filters the hard drive search results and lists in the right pane 410 only those search results containing both the search keyword strings entered by the user or extracted by the search engine or a program on the local computer and the selected concept(s), and not containing the excluded concept(s). In one embodiment, the more selected concepts a web page or file contains, the higher it is ranked in 408 or 410.

In one embodiment, as soon as a concept (other than the original search keyword strings) is selected or excluded, the search results are filtered instantly with the selected or excluded concept. In one embodiment, the original search keyword string is listed as the first concept in the List of Important Concepts, and the Select box for the original search keyword strings is automatically checked. A user can uncheck it. When a user un-checks the Select box or checks the Exclude box for the original search keyword strings, and check the “Select” box of other concept(s) in section 412, the search engine and the local hard drive search program interpret this as the user requesting a new search using the selected concept(s), and excluded concept(s) if the “Exclude” box is checked for any concept(s). Thus, the search engine and the local hard drive search program will perform a new search. In another embodiment, a new search is initiated only when a user un-checks the Select box or checks the Exclude box of the original search keyword strings, selects other concept(s) in section 412, and/or enters new keywords in the search box 426, and clicks the search button 427. The above embodiments facilitate a user in adjusting his search based on his new understanding from the search results returned. He can deselect or exclude the original search keyword strings, select or exclude the important concepts listed in 412, and enter new keywords in box 426 to re-formulate his search.

The search box 426 at the bottom in the left pane is for search with additional keywords. A user can select concepts, which may or may not include the original search keyword strings, enter new keywords in box 426, which may be expanded into concepts, and click the search button 427 to do another search using the selected and entered keywords or concepts. This search will be a refined search within the search results if the original search keyword strings are selected. It will be a new search if the original search keyword strings are not selected or excluded.

In yet another embodiment, the original search keyword string is not listed in the List of Important Concepts in 412 or 612. A “Search within Results” button and a “New Search” button are provided. When a user clicks the “Search within Results,” the search is conducted with a search keyword string that includes the original search keyword(s). When a user clicks “New Search,” a new search is performed without including the original search keyword(s).

In one embodiment, the List of Important Concepts is updated after conceptual filtering to list the top ranked N important concepts extracted from web pages and files that remain in the filtered search results. In another embodiment, the List of Important Concepts does not changed after a conceptual filtering and remains the same as the original search, so that a user can continue conceptual filtering of the original search results. In yet another embodiment, a user is given the option to choose either the updated List of Important Concepts representing the filtered search results or the original List of Important Concepts representing the original, un-filtered search result is displayed.

The “Stats” in the user interface illustrated in 412, 416, 612 and 616 means the statistics of the important concept or filtering feature in the same line. In one embodiment, this statistics is the number of web pages or files in the search results that contain the important concept/keyword(s) or that match the filtering feature. In another embodiment, the “Stats” item contains more than one statistics, e.g., the total number of appearances of an important concept in the search results.

Concept extraction of web pages can be done beforehand at the search engine. In one embodiment, concept extraction is independent of searches. Thus, before a user conducts a search, the important concepts of web pages or files indexed at a search engine can be extracted, and a concept-to-pages/files index B_{SE} can be built at the search engine, in much the same way of building the keyword-to-pages/files index A_{SE} in order to support keyword searches. This way, when the search engine retrieves a web page or file using the index A_{SE} and search keywords supplied by a user, the important concepts contained in web page or file may be instantly available using the index BSE. Similarly, a page/file-to-concepts index C_{SE} may also be built at a search engine beforehand. In one embodiment, concept extraction, filtering and mapping (to be discussed in detail later) of pages and files in the web are carried out in a search engine of this invention, and concept extraction, filtering and mapping of files in the hard drive(s) of a use's local computer or local network are carried out in a program of this invention that is run on the user's local computer. The flow of operation in this embodiment is given below:
1. A user enter NLDS or keyword(s) using a search engine interface such as 100 or 300 or a conventional search engine interface similar to Yahoo or Google, and initiates a search. A control program detects this event, and sends the search request and description to a search engine embodiment of this invention and to a hard drive search program if hard drive search is enabled.
2. A search engine embodiment of this invention extracts search intention and keyword strings, performs keyword to concept expansion, and generates search keyword strings to be used to perform the search. If a conventional search engine interface similar to Yahoo or Google is used, the keywords entered by the user are directly used as the search keyword string(s) to perform the search.
3. If hard drive search is enabled, the control program initiates a hard drive search program installed on the user's local computer to extract keyword strings, performs keyword to concept expansion, and generates search keyword strings to be used for search. If a conventional search engine interface similar to Yahoo or Google is used, the keywords entered by the user are directly used as the search keyword string(s) to perform the search. If hard drive search is not enabled, skip this step.
4. The search engine uses the search keyword string(s) to retrieve web pages and files containing the search keyword string(s) from a keyword-to-pages/files index referred to as Index A_{SE} that is built beforehand. The search engine retrieves the important concepts contained in the search results using a page/file-to-concepts index referred to Index C_{SE} that is built beforehand. The search engine then ranks the web pages and files, and the concepts, returns the ranked list of search results, and the ranked list of the top N concepts to a user interface program running on the user's local computer that displays the search results, concepts and concept path maps to the user to fill the fields and panes in the interface 400. In one embodiment, the search engine uses a pages/files-to-concepts index referred to Index C_{SE} that is built beforehand to retrieve and display the important concepts contained in a web page or file to the user when the user selects the listing of a web page or file in the search result.
5. If hard drive search is enabled, the hard drive search program uses the search keyword string(s) to retrieve files containing the search keyword string(s) from a keyword-to-pages/files index referred to as Index A_{PC} built beforehand. The hard drive search program retrieves the important concepts contained in the search results using a page/file-to-concepts index referred to Index C_{PC} built beforehand. The hard drive search program then ranks the files and the concepts, returns the ranked list of search results, and the ranked list of the top N important concepts to a user interface program running on the user's local computer that displays the search results, concepts and concept path maps to the user to fill the fields and panes in the interface 400. If hard drive search is not enabled, skip this step.
6. As user floats the cursor on top of a concept or clicks the “Select” or “Exclude” boxes of concepts in the concept list 412, or selects the time range, sources, file types, etc., in 416, a filtering program in the search engine filters the web search results and only displays web results that meet the selections in the middle pane 408. To perform filtering of web search results by the concepts selected by a user in 412, the search engine uses a concept-to-pages/files index B_{SE} that is built beforehand to retrieve the list of web pages and files and find intersections of such lists retrieved using each of the selected concepts. The search engine also uses the concept-to-pages/files index B_{SE} to construct a concept path map for the web search results.
7. If hard drive search is enabled, a local filtering program filters the hard drive search results and only displays hard drive results that meet the selections in the right pane 410, if hard drive search results and web search results are shown on the same browser window as in 400. If “Hard Drive Search in New Window” is enabled, filtering of web search results and filtering of hard drive search results are processed and displayed separately. To perform filtering of hard drive search results by the concepts selected by a user in 412, the local filtering program uses a concept-to-pages/files index B_{PC} that is built beforehand to retrieve the list of files and find intersections of such lists retrieved using each of the selected concepts. The local user interface program also uses the concept-to-pages/files index B_{PC} to construct a concept path map for the hard drive search results.

The search engine of this invention builds indexes A_{SE}, B_{SE}, and C_{SE} beforehand, i.e., before a search is performed so that the indexes are ready to be used when a user does a search using the search engine. It updates these indexes periodically to keep them up to date with the contents in the Internet. The hard drive search program of this invention also builds indexes A_{PC}, B_{PC}, and C_{PC} beforehand, the formats of which are similar the ones shown above. In one embodiment, these indexes are built when the hard drive search program is first installed, and are updated periodically with a default period, which can be changed by a user, to keep them up to date with the changes to the files in the local computer's hard drive(s). Building these indexes beforehand enables fast processing of the functions of this invention.

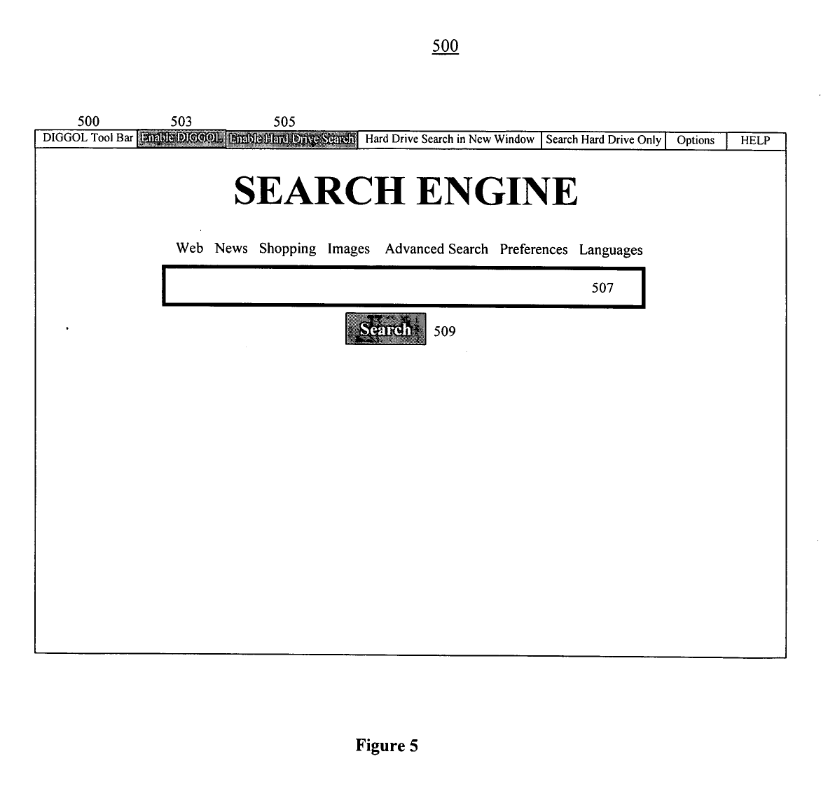

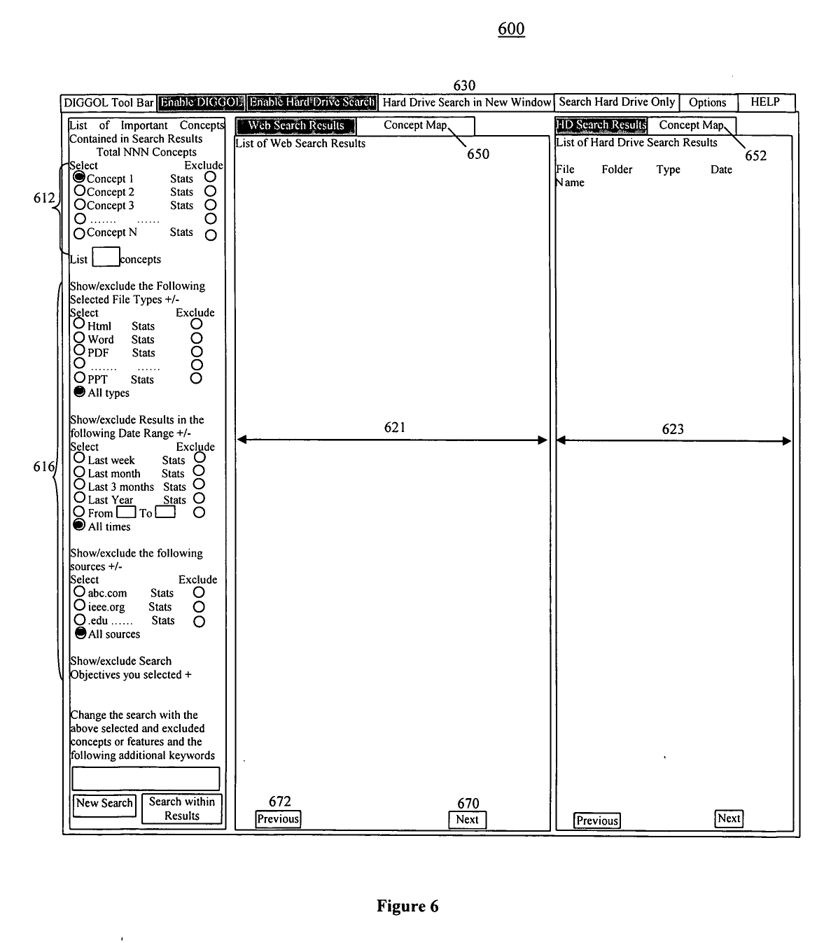

The above embodiment requires an Internet search engine implementing embodiments of this invention and user's visiting this search engine on the Internet to perform web searches. In another embodiment, a user uses a search engine of his choice, e.g., Yahoo or Google, and the concept extraction, filtering and mapping of this invention are implemented in a user's local computer. One way is to use a web browser plug-in program, e.g., a Microsoft Internet Explorer plug-in program, to link the search engine results and the concept extraction, filtering and mapping functions of this invention. FIG. 5 shows a conventional search engine interface and a web browser with a tool bar interface to embodiments of this invention. A user clicks the “Enable DIGGOL” button 503, shown as highlighted in FIG. 5, to enable the functions of this invention. When the functions of this invention are enabled and a user enters search keyword strings into box 509, and clicks “Search” button 509, the functions of this invention are initiated. In one embodiment, a new browser window 600 shown in FIG. 6 is opened. If the “Enable Hard Drive Search” button 505 is clicked, the new browser window in FIG. 6 contains a pane 623 for local hard drive search results in the right as well as a pane 621 for webs search results in the middle. In this embodiment, concept extraction, filtering and mapping of pages and files in the web, as well as concept extraction, filtering and mapping of files in the hard drive(s) of a use's local computer or local network are all carried out in a program of this invention that is run on the user's local computer. The flow of operation in this embodiment is shown below.
1. A user enters search keyword string(s) into a conventional web search engine of his choice, for example, a search engine similar to Yahoo or Google, and requests the conventional web search engine to perform a web search. A control program running on the user's local computer detects this search event, opens a browser window 600, and sends the search keyword string(s) to a hard drive search program if hard drive search is enabled.
2. The conventional web search engine returns the list of web search results to the search engine interface on the user's local computer. The control program on the user's local computer detects this event and initiates a local download program. The download program downloads the list of search results returned by the search engine. It either downloads each of the web page or file in the search results from the search engine, e.g., using a web service protocol, or extracts the URLs from the list of search results returned by the search engine and downloads the web page or file in the search results from their respective URLs. In one embodiment, the download program calls a virus scan program to scan downloaded web pages or files. In one embodiment, a local ranking program ranks the search results based on the search engine's ranking and a set of local ranking rules to rank the search results.
3. A local concept extraction program extracts the important concepts from the downloaded web pages and files and builds a concept-to-page/file index B_{IP} that can use a concept to retrieve the list of web pages or files that contain the concept. In one embodiment, the local concept extraction program also builds a pages/files-to-concepts index referred to Index C_{IP} so that when a user selects the listing of a web page or file in the search result, the user interface program can use the C_{IP} index to retrieve and display the important concepts contained in the web page or file to the user. A local ranking program ranks the web pages and files using a combination of search engine ranking and relevancy ranking. The local ranking program also ranks the extracted concepts in each document, and ranks the pool of concepts from all analyzed web pages and files so that the top N concepts can be selected for listing in section 612. The ranked search results and the ranked list of the top N concepts are sent to a user interface program running on the user's local computer that displays the search results, concepts and concept path maps to the user to fill the fields and panes in the interface 600.
4. If hard drive search is enabled, the hard drive search program uses the search keyword string(s) to retrieve files containing the search keyword string(s) from a keyword-to-pages/files index referred to as Index A_{PC} that has been built beforehand. The hard drive search program retrieves the important concepts contained in the search results using a page/file-to-concepts index referred to Index C_{PC} built beforehand. The hard drive search program then ranks the files and the concepts, returns the ranked list of search results, and the ranked list of the top N concepts to a user interface program running on the user's local computer that displays the search results, concepts and concept path maps to the user to fill the fields and panes in the interface 600. If hard drive search is not enabled, skip this step.
5. As user floats the cursor on top of a concept or clicks the “Select” or “Exclude” boxes of concepts in the concept list 612, or selects the time range, sources, file types, etc., in 616, a local filtering program filters the web search results and only displays web results that meet the selections in the middle pane 621. To perform filtering of web search results by the concepts selected by a user in 612, the local filtering program uses the concept-to-pages/files index B_{IP} that is built in step 3 above to retrieve the list of web pages and files and find intersections of such lists retrieved using each of the selected concepts. The local filtering program also uses the concept-to-pages/files index B_{IP} to construct a concept path map for the web search results.
6. If hard drive search is enabled, the local filtering program filters the hard drive search results and only displays hard drive results that meet the selections in the right pane 623, if hard drive search results and web search results are shown on the same browser window as in 600. If “Hard Drive Search in New Window” is enabled, filtering of web search results and filtering of hard drive search results are processed and displayed separately. To perform filtering of hard drive search results by the concepts selected by a user in 612, the local filtering program uses a concept-to-pages/files index B_{PC} that is built beforehand to retrieve the list of files and find intersections of such lists retrieved using each of the selected concepts. The local user interface program also uses the concept-to-pages/files index B_{PC} to construct a concept path map for the hard drive search results.

In one embodiment, the number of web pages or files M or the number of megabytes K that are to be downloaded initially is set by default or by a user. M and K are positive integers, e.g., M=1,000, meaning that 1,000 web pages and files are initially downloaded, or K=100, meaning that web pages and files are initially downloaded until they fill 100 MB. After a first set of web pages and files that reaches the M or K limit, the download program temporarily stops the downloading, and saves a first pointer that points to the next web page or file to be downloaded in the original search results. When most of the downloaded first set of web pages and files has been processed, e.g., 900 web pages and files, or 90 MB have been processed, and the user has not stopped the original search or closed the program or started a new search, the control program activates the download program to start downloading again. The download program will uses the first pointer to start the download from the 1,001^{st} web page or file or from the next web page or file after the downloading was stopped before exceeding 100 MB.

Another embodiment is a blend of the above two embodiments where the concept extraction and building of indexes A_{SE}, B_{SE}, and C_{SE} are done beforehand at the search engine, but the conceptual filtering and concept path map generation are performed on a user's local computer. To do this, at search time, the search engine reduces the index B_{SE}, and in some cases the index C_{SE}, to contain only the web pages and files, and the concepts contained therein, in the search results. We refer to these indexes as B′_{SE}, and in some cases the index C′_{SE} respectively. A local download program downloads the indexes B′_{SE} and C′_{SE} for the search results to a user's local computer. Then, the local filtering program and concept path map generation program can use the downloaded indexes to perform conceptual filtering and to construct concept path maps. Downloading the indexes B_{SE} and C_{SE} that are built beforehand saves processing time so that conceptual filtering results and CPM can be shown to a user without much delay. On the other hand, using the downloaded the indexes B′_{SE} and C′_{SE} to perform conceptual filtering and conceptual path mapping of the search results on a user's PC makes use the vast computing resources available at millions of PCs.

Another flexibility of task division between a local computer and the search engine server is the extraction of search keyword strings from NLDS and the expansion of keywords in 100 and 300 to concepts. In one embodiment, they are performed in a search engine server connected to the Internet, while in another embodiment, they are performed by a local computer that generates conceptually expanded search keyword strings and search combinations and sends them to a search engine server in the Internet. The search engine directly uses the submitted search keyword strings to perform search. Performing the extraction of search keyword strings from NLDS and the expansion of keywords makes use the vast computing resources available at millions of PCs.

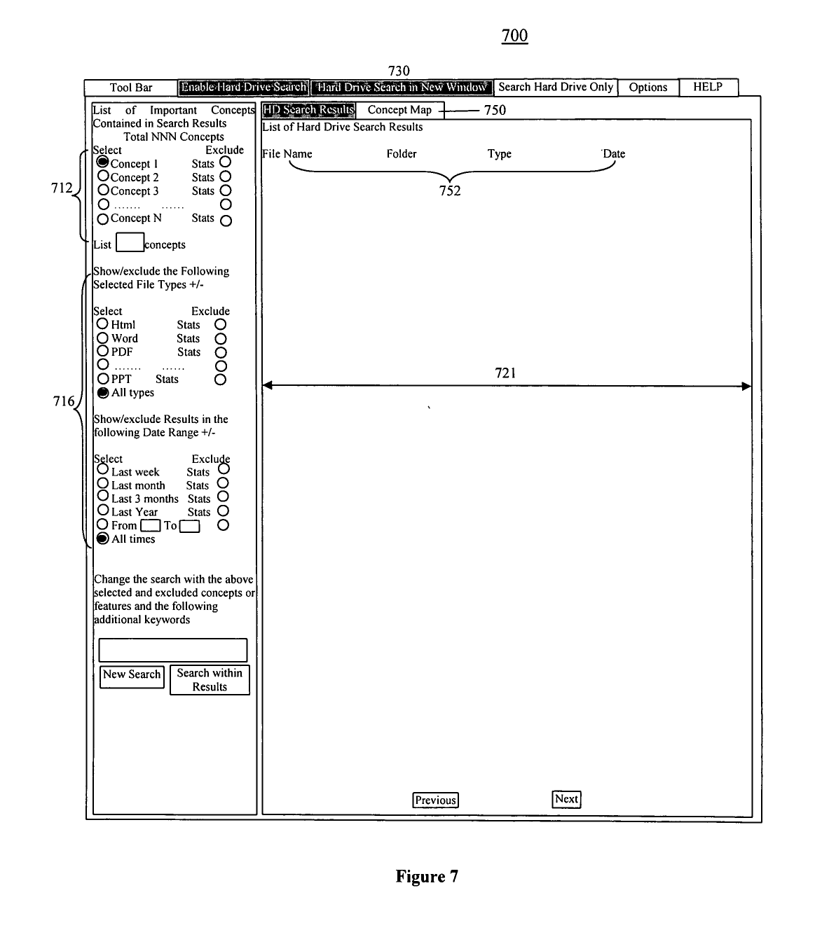

In cases where a user clicks “Hard Drive Search in New Window,” the hard drive search is shown in a separate window as in FIG. 7.

Methods for ranking of search results and the conceptually filtered results are described in a later section.

Concept Path Maps

Prior art search engines only show search results in a linear list. A user has to go page after page and scroll to see the listings. Clustering search engines provide a list of categories and a user has to click on a category to see what subcategory, if there is any in the category. This invention provides to a user simple graphical visualizations that show how the search results are logically and/or statistically distributed or organized by the important concepts that are contained in the search results. The graphical visualizations are referred to as Concept Path Maps (CPM) or Concept Maps for short. When a user selects to display Concept Map by clicking 450 or 452 in 400, or 650 or 652 in 600, or 750 in 700, a concept map generation program generates a concept map of the search results based on the concepts listed in the left pane in section 412, or 612, or 712 respectively, and a user interface program displays the concept map in the browser window 400, or 600, or 700 respectively. One embodiment offers a user two options of concept maps from which a user can pick which one to show: the Most Popular Path (MPP) concept map or the Most Original Path (MOP) concept map, as defined later. A more logically descriptive name for the MPP is a Maximum Intersection Path, and a more logically descriptive name for the MOP is Minimum Intersection Path. Note that in one embodiment, the concepts or important concepts above may be keywords or phrases extracted from the search results.

Below we illustrate the CPM using 10 extracted concepts in 100 search results. The search results may be web pages or files on the Internet or in a local computer or local network's hard drive(s). Let the 10 concepts be denoted by A,B,C,D,E,F,G,H,I,J, and A is the search keyword string. Note that in application, each of these concepts will be a keyword or set of keywords or a phrase. For example, if a user searches with the search keyword string (rising cost of oil), then A=(rising cost oil), note that “of” is not used as a search keyword because it is in the Search Word Extraction Exclusion List, and the other concepts may be: B=(OPEC), C=(Iraq war), . . . , I=(Russia), J=(Yukos). Assume that statistics of the concepts in the 100 files are: A=100, B=70, C=55, D=50, E=41, F=38, G=30, I=10, J=2, where the number means the number of web pages or files that contain the concept, e.g., B=70 means that there are 70 web pages or files that contain the concept B (or OPEC in the above example).

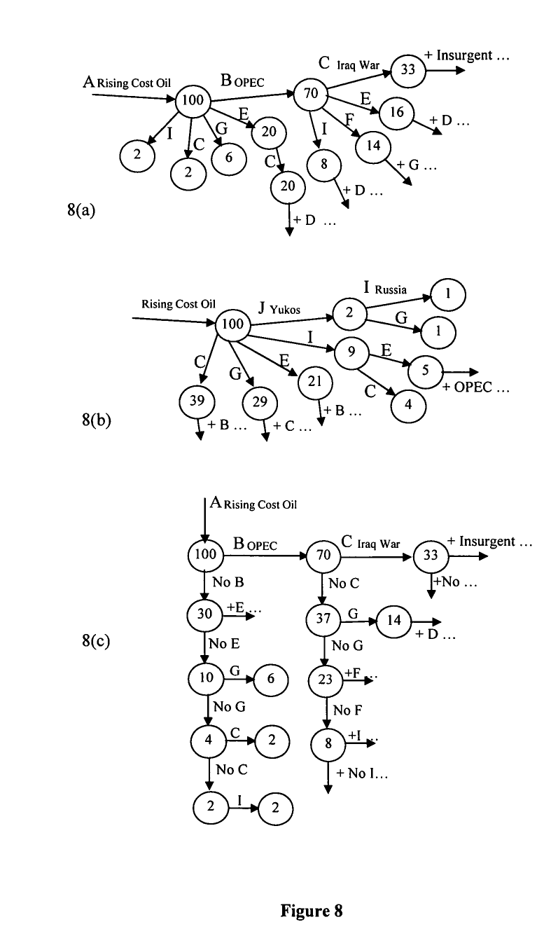

In an MPP CPM as shown in FIG. 8(a), the most popular concept or the maximum intersection concept, i.e., the concept that is contained in the most number of search results, is first chosen as the transition path to the next node in the CPM. A concept on a transition path functions like a filter such that only search results that contain this concept labeled on the transition path will be able to flow to the next node. In one embodiment, the order from the most popular to less popular is arranged from top right to lower and to the left. In the above example, in the first level after the search keyword string A, B is the most popular concept and thus is used as the first level-1 transition path at the top right, referred to as level-1 path B, leading to a node with 70 search results. The rest of the first level transition paths, denoted as nB (nB=not containing B) paths, have a subset of 30 web pages or files. Assume that other than A, concept E is the most popular concept in the nB subset with E=20. Thus E is used as the second level-1 transition path below level-1 path B, leading to a node with 20 search results. In the nBnE subset of 10, assume that concept G is the most popular concept other than A with G=6. Thus G is used as the third level-1 transition path below and to the left of level-1 path E, leading to a node with 6 search results. In nBnEnG subset of 4, assume that two concepts, C and I, are the most popular other than A, and both have the same number of search results, C=2, I=2. Then C and I are used as the fourth and fifth level-1 transition paths to the left of level-1 path G, each leading to a node with 2 search results. When two transition paths have the same popularity, they can be arranged by the ranking of the concepts with the transition path of the highest ranked concept being on the top and to the right, or arranged by alphabetical order of the concepts. At the second level of the MPP CPM, in the B subset of 70, assume that concept C is the most popular concept other than A and B with C=33. Thus C is used as the first transition path in level-2 at the top right, after the level-1 path B, leading to a node with 33 search results. In the BnC (containing B but not C) subset of 37, assume that concept E is the most popular concept other than A and B with E=16. Thus E is used as the second level-2 transition path at below the B subset level-2 path C, leading to a node with 16 search results. In the BnCnE subset of 22, assume concept F is the most popular concept other than A and B with F=14. Thus F is used as the third transition path in the B subset level-2 to the left of B subset level-2 path E, leading to a node with 14 search results. The concept map can continue to be expanded until all listed concepts contained in the web pages or files belonging to a node have been used in the transition path leading to the node, or when there is only one search result left in a node. A concept path is a sequence of transition paths following which the search results are filtered in the same order of the concepts associated with the transition paths, e.g., concept paths ABC, ABG, AECD in FIG. 8(a), where ABG is actually AB(nC)G, and AECD is actually A(nB)ECD. Note that the order of the concepts in a path is important because the search results are filtered by these concepts in the order of the path.

In an MOP CPM as shown in FIG. 8(b), the rarest concept or the minimum intersection concept, i.e., the concept that is contained in the least number of search results, is first chosen as the transition path to the next node in the CPM. The fact that a concept is contained in the least number of search results may likely mean that it is a very new or unique viewpoint or observation or discovery, etc., thus it may be highly original or informative. An MOP CPM aims to dig out such web pages or files out of a large number of cluttered search results, and clearly and obviously presents them to a user. In an MOP CPM, the web pages or files that contain the least popular concepts can be brought out in a very small number of transitions and can be displayed in a prominent position. Similar to the MPP, a concept on a transition path functions like a filter such that only search results that contain this concept labeled on the transition path will be able to flow to the next node. In one embodiment, the order from the rarest or least popular to the more common or more popular is arranged from top right to lower and to the left. In the above example, in the first level, J is the least popular concept and thus is used as the first level-1 transition path at the top right, leading to a node with 2 search results. The rest of the first level transition paths, denoted as nJ paths have a subset of 98 web pages or files. Assume that concept I is the least popular concept in the nJ subset with I=9. Thus I is used as the second level-1 transition path below level-1 path J, leading to a node with 9 search results. In the nJnI subset of 89, assume that concept E is the least popular concept with E=21. Thus E is used as the third level-1 transition path below and to the left of level-1 path I, leading to a node with 21 search results. In nJnInE subset of 68, assume that concept G is the least popular concept with G=29. Thus G is used as the fourth level-1 transition path to the left of level-1 path E, leading to a node with 29 search results. In nJnInEnG subset of 39, assume that concept C is the least popular concept with C=39. Thus C is used as the fifth level-1 transition path to the left of level-1 path G, leading to a node with 39 search results. At the second level of the MOP CPM, in the I subset of 2, assume that concepts I and G are least popular with I=1 and G=1. Thus I and G are used as the first and second level-2 transition path at the top right, after the level-1 path J, each leading to a node with 1 search result. When two transition paths are both least popular, they can be arranged by the ranking of the concepts with the transition path of the highest ranked concept being on the top and to the right, or arranged by alphabetical order of the concepts. The MOP CPM can continue to be expanded until no more listed concepts are contained in a node, or when there is only one search result contained in a node.

In general, due to limited screen space, a concept map sometimes only shows the transition paths and nodes in the first one or two levels. Other transition paths and nodes are condensed. The condensed portion is shown with a + sign and a list of remaining concepts. Clicking on the + sign will expand the CPM one more level. The list of remaining concepts can be a partial list only showing the first word. When the cursor is moved on top or clicked on the partial list, a suspend window pops up and shows the full list of remaining concepts. A user can expand or condense the CPM by clicking on + or −.

In one embodiment, the CPM also shows the negation path and node, e.g., using the MPP in the above example, a negation transition path at the first level is a “No B” path, which means all search results not containing concept B can go through to the next node along this path. A negation mode, in the first level of the MPP example above, an nB node, is the node that contains all the search results that do not contain the concept B. This is illustrated with the MPP example above in FIG. 8(c), which shows the MPP of the above example with negation paths and negation nodes. In this CPM, each transition path is labeled with a concept as in FIGS. 8(a) and 8(b). Each transition path pointing to a first node is like a selective vacuum valve. It sucks into the said first node all web pages or files containing the concept labeled on the transition path pointing to the said first node, and all remaining web pages and files continue to flow downward. Variations of the CPM in FIG. 8 and other alternate graphical representations can also be used to represent the CPM.

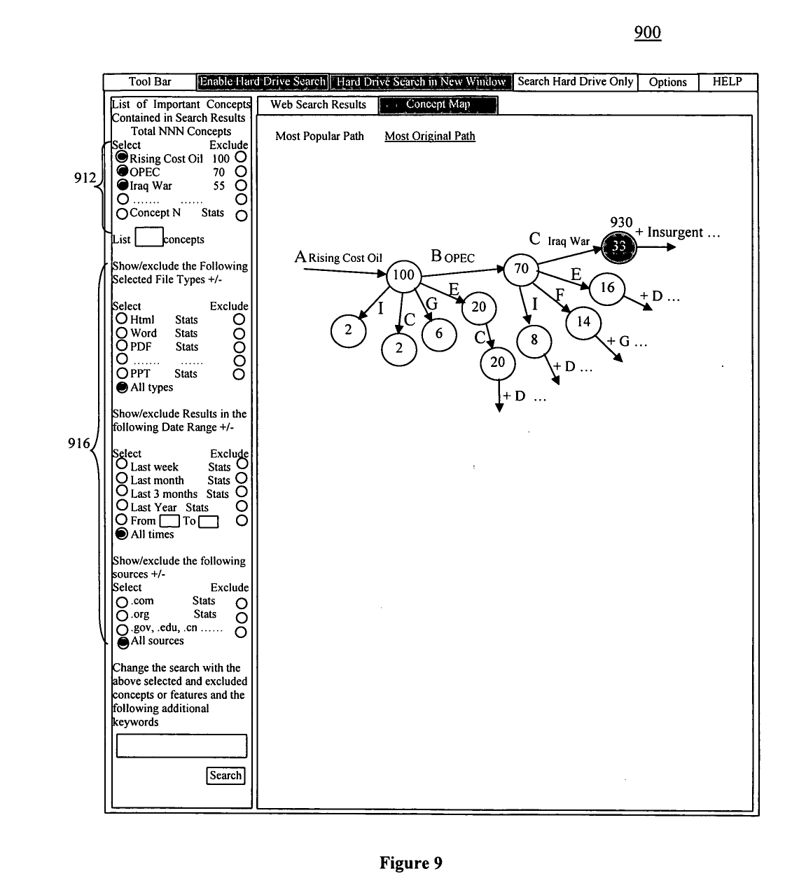

When a user selects “Concept Map” in the search results pane and one or more concept(s) are selected in left pane in section 412 or 612 or 712 or 912, the node(s) in the CPM that contain the web pages or files that contain the concept(s) selected in the left pane will change into a highlight or different color or different shading, thus, enabling a user to quickly locate the node or cluster, and the web pages or files by clicking the highlighted or colored or shading node(s). This is illustrated in FIG. 9 with a MPP CPM where the search keywords (Rising Cost Oil), and the two concepts (OPEC) and (Iraq war) are selected in section 912 in the left pane, and the node 939 in the CPM changes into a different shading because it contains all the selected concepts. Note that in FIG. 9, hard drive search is not enabled, thus there is no display of hard drive search result. For a node in the CPM to be highlighted or change shading or color, a concept map generation program uses the index B_{SE} or B_{IP}, or B_{PC}, to map the concept(s) selected by a user to web pages or files that contain the selected concept(s). Mapping to a web page may include a pointer to a short summary of the web page and the URL of the web page. Mapping to a file may include a pointer to a short summary of the file and the full path of the file. Using the set of web pages or files retrieved from the index B_{SE} or B_{IP}, or B_{PC} using each selected concept, the concept map generation program finds the intersection set of the said sets for all selected concepts. Then, using the said intersection set, it finds and highlights the CPM node(s) that contains the intersection set. When a user clicks a node in the CPM, all the web pages or files belonging to that node can be displayed as a list of abstracts and URLs in the search results pane. To accomplish this, the concept map generation program can build an index or list that lists all the web pages or files belonging to a node for each node of the CPM. This can be done when the concept map generation program is constructing the concept map.

Both of the MPP CPM and MOP CPM provide a clear holistic visual view of how the search results are statistically and/or logically are distributed or organized. This is difficult to achieve with the prior art search engine techniques and interface. A user can quickly see the effects of filtering by concepts by following a concept path or by selecting concepts in the left pane to see which nodes are highlighted. A concept path of an MPP concept map is a path of successively clustering of search results by the most popular concept at a level. Popularity can be considered as the collective votes on what is considered important. Thus, a concept that is mentioned in a large number of web pages or files may be considered to be important or of value by the authors of such large number of web pages or files. In an MPP CPM, the web pages or files that contain the most popular concepts at each level are displayed to a user in a prominent position. A concept path of an MOP concept map is a path of successively clustering of search results by the rarest or likely the most original concept at a level. An MOP CPM aims to dig out a view that is original, or in early stage, or not widely recognized, thus, potentially of value.

The transition path in a CPM can be based on other relations than the MPP or MOP described above. In one embodiment, the transition path is based on a logic or semantic relation between the two nodes, i.e., the two subsets represented by the nodes. If the two subsets of web pages or files contained in the two nodes contains contents that match the said logic or semantic relation, then a transition path is drown between the two nodes with the said logic or semantic relation as the transition path. In one embodiment, the said logic or semantic relation is a prerequisite or precondition relation, and if the web pages or files in node A contains the prerequisite or precondition of some contents in the web pages or files in node B, a transition path is drown from node A to node B, and the transition path is labeled as a prerequisite transition.

Indexing Structure for Concept Display, Conceptual Filtering and Concept Path Maps

In the previous sections, three types of indexes are described:
The keyword-to-pages/files index A_{SE} and A_{PC},
The concept-to-pages/files index B_{SE}, B_{IP}, and B_{PC},
The page/file-to-concepts index C_{SE}, C_{IP}, and C_{PC.}

In one embodiment, the formats of the three indexes are:
A_{SE} and A_{PC}: {[keyword_{—}1, (page_{—}1, file_{—}2, . . . , number of pages/files)], [keyword_{—}2, (file_{—}1, page_j, . . . , number of files)], . . . }
B_{SE}, B_{IP}, and B_{PC}: {[concept_{—}1, (file_{—}1, page_{—}2, . . . , number of pages/files)], [concept_{—}2, (file_i, page_j, number of pages/files)], . . . }
C_{SE}, C_{IP}, and C_{PC}: {[page_{—}1, (concept_{—}1, concept_{—}2, . . . , number of extracted important concepts)], [file_i, (concept_j, concept_k, number of extracted important concepts)], . . . }
   In the above, for a web search result, page_i and file_j can contain the name or title and the URL of the web page or file, and a pointer to the version of the web page or file downloaded and saved in the local hard drive; for a file in the user's local computer, file_j can contain the name and the path of the file.

The difference between the indexes A_{SE} and A_{PC} and the indexes B_{SE}, B_{IP}, and B_{PC} is that the indexes A_{SE} and A_{PC} must include all keywords that a user may use to search the web pages or files, except those in the SWEEL, while the indexes B_{SE}, B_{IP}, and B_{PC} only contains the concepts, e.g., words or phrases or word strings, that are considered important and are extracted as important concepts. An entry in the indexes A_{SE} and A_{PC} is a single keyword or a frequently used phrase, and an entry in the indexes B_{SE}, B_{IP}, and B_{PC} can be a string of words that is extracted from a web page or file as is, and may be more than a simple phrases.

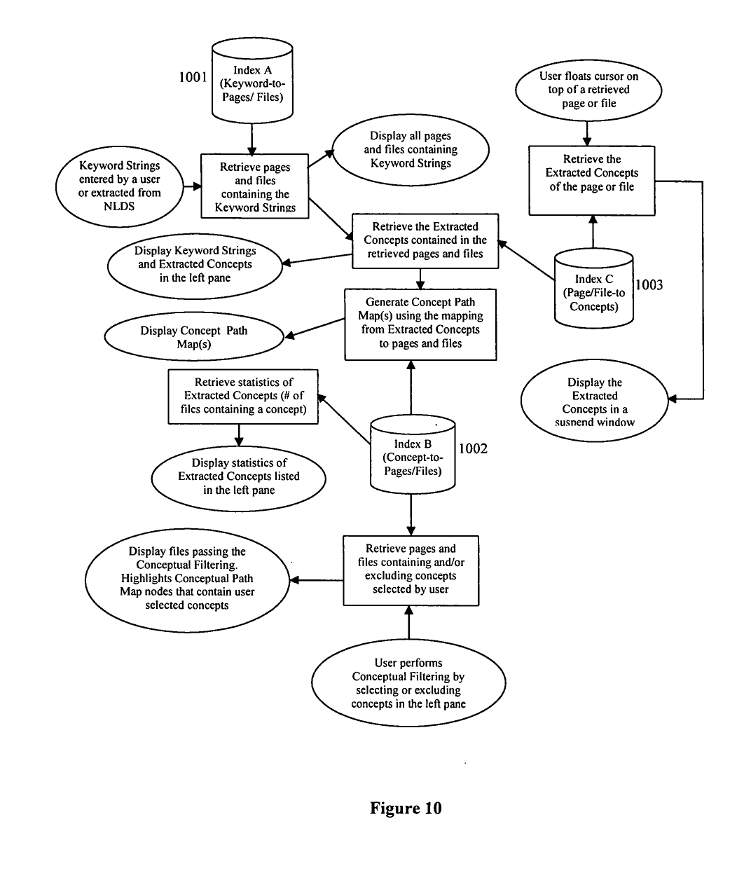

The functional block diagram for A_{SE} 1001, B_{SE} 1002 and C_{CE} 1003 for web search when the extraction and building of indexes A_{SE}, B_{SE}, and C_{SE} are done beforehand at the search engine, and all three indexes are maintained at a search engine, is shown in FIG. 10. The oval boxes in FIG. 10 show user input and system output display. The rectangular boxes in FIG. 10 show operations performed by programs of this invention. The cylindrical boxes 1001, 1002 and 1003 in FIG. 10 show the index file or database. This same functional block diagram also applies to A_{PC}, B_{PC}, and C_{PC} for searching of files in a local computer's hard drive where all three indexes are built and maintained at the local computer. For other embodiments that blends of the above two embodiments, the functional block diagrams will be similar to FIG. 10 except they may be maintained or used in different locations, e.g., on search engine server, or user's PC, or parts of in on both.

To support fast retrieval and fast updating, suitable data structures from the state of the art can be used for structuring the indexes including hashing function or table, inverted index, B+tree, grid file, multidimensional B-tree structure, etc.

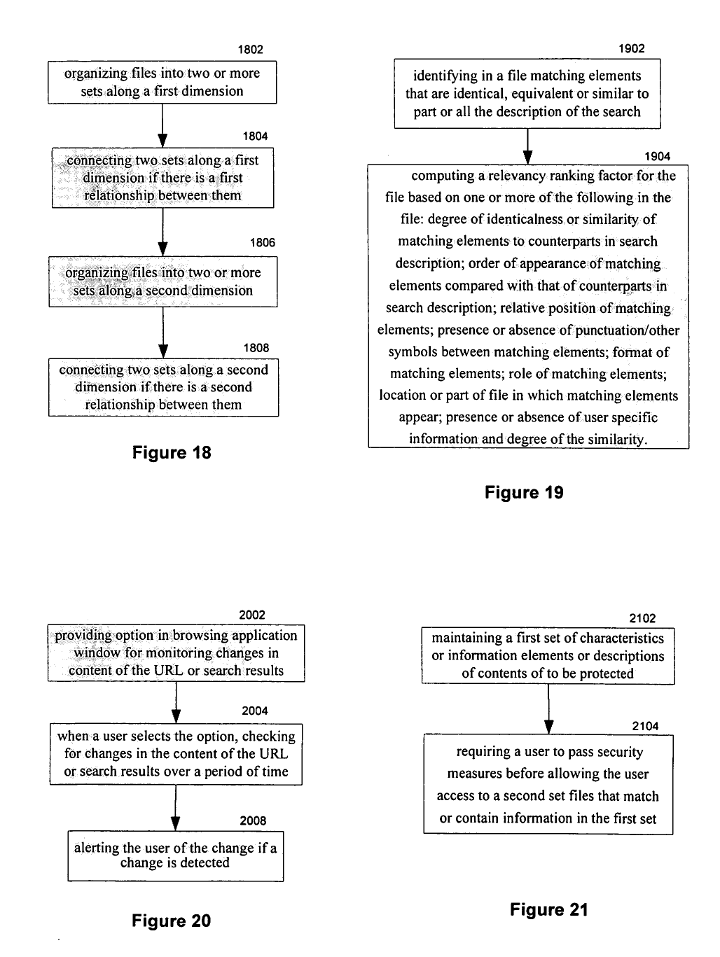

The embodiments of CPM, MPP and MOP provide a new method for displaying or organizing files into a structure, comprising, as shown in FIG. 18, organizing two or more files into two or more sets along a first dimension where the set membership is based on one or more information elements about or contained in the files (1802), connecting two sets along the first dimension if there exists a first relationship between the two sets (1804); organizing two or more files into two or more sets along a second dimension where the set membership is based on one or more information elements about or contained in the files (1806); and, connecting two sets along the second dimension if there exists a second relationship between the two sets (1808). For example, the first dimension is the horizontal axis, and the second dimension is the vertical axis. The method can be generalized to organizations of more than two dimensions.

In the above method, either one or both of the first relationship and the second relationship may be a subset relationship meaning that a set at one end of a connection is a subset of the set at another end of the connection, or may be a logic or a semantic relationship between the information elements of two sets connected by a connection.

When there are three or more sets joined by connections along either one or both of the first dimension and the second dimension, either one or both of the first relationship and the second relationship may be transitive. For example, in the CPM, if set A is a superset of B, and set B is a superset of C, then set A is also a superset of C. As shown in the CPM embodiments, the above method may display the structure as a graph or an image.

### Feature Filtering

In one embodiment, sections 416 and 616 list filtering features such as file types, dates of modification, sources, among other things, and provide a user interface for a user to filter the search results by these filtering features. A filtering feature extraction program extracts the sources, file types, date ranges, etc. and their statistics from the search results. In one embodiment, when a user selects more than one search objectives in 104 or 302 in the search engine interface, sections 416 and 616 also include a filed that categorizes the research results by the search objectives the user selected (shown as condensed in 400 and 600). When a user clicks a search objective listed in this section in 416, only search results matching the selected search objective will be displayed in web search results pane 408. The feature fields in 416 and 616 may be condensed and a user can expand or condense it by clicking on a + or − sign. Once a new feature field is selected for expansion, the previously expanded field is condensed and the newly selected filed is expanded. This allows the multiple sections to be fitted in a finite space.

In the Source field of 416 or 616, known source extensions, e.g., .gov, .edu, .tv, info etc., country extensions .cn, us, .ca, etc., and two level extensions .edu.cn, .gov.cn, .gov.uk, .ac.uk, etc., can be included. A source clustering program of the invention counts the number of web pages and files in the search results that are from a website or domain name, e.g., cnn.com, ieee.org, irs.gov, ucla.edu, etc. In one embodiment, the source clustering program selects the first S, where S is a positive integer and can be set by default or by user, websites or domain names, from which the most number of web pages and files are retrieved in the search results. These S websites or domain names are listed in the Source field in 416 or 616. This allows a user to filter the search results by including or excluding one or more of these listed websites or domain names.

A feature-to-pages/files index (FTFI) can be built for each filtering features in 416, 616 or 716, in similar manner as the concept-to-pages/files index B_{SE}, B_{IP} or B_{PC}. One format of the FTFI is shown below
{[filtering_feature_{—}1, (file 1, page 2, . . . , number of pages/files)], [filtering_feature 2, (file_i, page_j, number of pages/files)], . . . }
   Such an index can be used to support filtering by the selected or excluded features. When a filtering feature is selected, the FTFI for the feature can be used to retrieve the list of web pages and files with the selected feature, and these web pages and files can then be displayed or further filtered by finding the intersection set with other conceptual filtering and feature filtering results. When a filtering feature is excluded, the FTFI for the feature can be used to retrieve the list of web pages and files with the excluded feature, and these web pages and files can be removed from the search results display. Alternatively, the concept-to-pages/files index B_{SE}, B_{IP} or B_{PC} can be expanded to include other filtering features. One expanded format is shown below:
{[concept_{—}1, (file_{—}1, page_{—}2, . . . , number of pages/files)], [concept_{—}2, (file_i, page_j, . . . , number of pages/files)], . . . ,[filtering_feature_{—}1, (file_k, page_m, . . . , number of pages/files)], [filtering_feature_{—}2, (file_p, page_q, . . . , number of pages/files)], . . . }

The page/file-to-concepts index C_{SE}, C_{IP} and C_{PC} may be expanded to include the other filtering features. One expanded format is shown below:
{[page_{—}1, (concept_{—}1, concept=2, filtering_feature_{—}1, filtering_feature_{—}2, . . . , number of extracted important concepts)], [file_i, (concept_j, concept_k, filtering_feature_{—}1, filtering_feature_k, . . . , number of extracted important concepts)], . . . }

### Extract and Rank Concepts in Search Results or Files

Extracting Important Concepts

In one embodiment, important concepts are nouns, phrases, and acronyms that characterize a web page or file. This condenses a large web page or file and a large number of search results into a List of Important Concepts.

Detailed natural language processing and understanding will allow more accurate concept extraction. However, a key requirement is fast processing of a large number of web pages or files. One embodiment of this invention extracts, as important concepts, words or phrases that (1) are in specific positions or segments in a text file, e.g., title and section titles; (2) have specific statistics or characteristics, e.g., the x number of highest or lowest occurring words (excluding common words in an Important Concept Extraction Exclusion List), 2- or 3-word phrases, words with capitalized first letter or all capitalized letters, especially giving higher rank to phrases of more than two words with capitalized first or all letters, words that highlighted, bold or italic, underlined or in different font or color, and (3) are in the same sentence with search keywords, in the same sentence with words and their synsets in the Important Word/Phrase List (IW/P List), and in a set of sentence patterns that contain words in the IW/P List.

Each language has a set of sentence patterns and words that are used in such sentence patterns to emphasize the importance of a statement. Identifying such words and sentence patterns may help identify sentences in a textual file that contain important thesis, conclusion, viewpoints, question or summary of an article. Thus, important concepts can be extracted from such sentences. In one embodiment, using English language as an example, the IW/P List consists of three groups of words. Note that each word can be expanded to all its synsets and forms, e.g., noun, verb, present, past and future tenses, adjective, and adverb. Note that given the limited space, only subset of each group is given below as examples.
IW/P List Group 1: Concepts extracted based on words or phrases in this list have a medium rank. (better, more, worse, require, outcome, result, important, significant, interesting, true, depend, independent, surprising, oversight, overlook, mistake, investigate, research, study, explore, look into, concept, intriguing, worthwhile, worth, special, specialized, need to, consider, evaluate, improve, enhance, advance, necessary, sufficient, insufficient, standard, new, innovative, overcome, efficient, inefficient, backward, old, outstanding, new, alternative, all -er adjectives or adverbs, etc.)
IW/P List Group 2: Concepts extracted based on words or phrases in this list have a high rank. (best, most, worst, referred to as, is/are/was/were called, abbreviated as, critical, crucial, vital, purpose, objective, goal, key, main, major, overwhelming, striking, remarkable, extreme, exceeding, disaster, necessary and sufficient, iff, fundamental, all -est adjectives or adverbs, etc.)
IW/P List Group 3: Concepts extracted based on words or phrases in this list have the highest rank. (key idea, main idea, major idea, main purpose, main objective, main goal, main problem, major problem, main difficulty, main obstacle, break through, breakthrough, major development, major innovation, invention, discover, groundbreaking, break new ground, new record, world record, record high, record low, unparallel, unprecedented, revolutionary, unexpected, never, etc.)

Common words that are in an Important Concept Extraction Exclusion List (ICEEL) may be excluded from the extraction of important concepts. Note that a subset of the ICEEL can be used for the SWEEL. A subset of words in an example ICEEL is shown below: (Single letters or numerical number with less than 3 digits; about after all am among an and another any anybody anything anytime are as at be been but by call called can could did do down each eight everybody find first firstly five for four from had has have he her him his how if in into is it its just know like little made make many may more Mr. Mrs. Ms. much my nine no not now of on one only or other out over people said second secondly see seven shall she should six so some somebody something sometimes ten that the their them themselves then there these they thing third thirdly this those three to two up use very via was way we were what when where which who whom will with words would you your, etc.)

Extraction of Important Concept Using the IW/P List

In one embodiment, extracting important concepts using the IW/P List is done by identifying a sentence containing one or more words from the IW/P List, cutting off any part crossing any punctuation marks, or crossing any definitive clauses (i.e., those that start with: that, those, who, whom, which), removing all words in the ICEEL, then keeping all the remaining words as the extracted concept. A detailed description of this embodiment is the following sequence:
1. Extract all words other than words in the Extraction Exclusion List from the sentence (not crossing period (.) or semi-colon (;) or quotation (“or” or ‘or ’), or (:), but can cross comma) containing at least one word or phrase from the IW/P List. If the number of words extracted is less than 5, stop. Otherwise, go to step 2.
2. Remove words in the above sentence that cross comma. If the number of words extracted is less than 5, stop. Otherwise, go to step 3.
3. Further remove words in the above sentence that cross a definitive clause or a descriptive phrase using a verb phrase. If the number of words extracted is less than 5, stop. Otherwise, go to step 4.
4. Further remove words in the above sentence that cross a preposition word (in, on, with, from etc., but not include “of” and “to”). If the number of words extracted is less than 5, stop. Otherwise, go to step 5.
5. Further remove words in the above sentence that cross the word “of” or “to”. If at least one word is extracted in addition to the word in the IW/P List, stop. Otherwise, use the words extracted in step 4.
   It is important the extracted words are kept in the exact same order as they appear in the original sentence.

In another embodiment, sentence patterns are used in conjunction with words in the IW/P List to extract only the most important words from the sentence containing one or more words from the IW/P List. The same rule of not crossing any punctuation marks and not crossing any definitive clauses apply. This requires making use of a set of known sentence patterns, e.g., “the goal of this study is to . . . ”, “the conclusion is . . . . ”, etc., and applying part-of-speech analysis to identify subject, verb, object, definitive clause etc., and word type analysis to identify nouns, verbs, to be, etc., to sentences identified by sentence pattern and/or a word or phrase in IW/P List, and/or search words. Other examples of sentence patterns from which concepts should be extracted are “The (adjective) objective is . . . ”, “(noun phrase) provides (noun phrase)”, “(noun phrase) enables (noun phrase)”, “(noun phrase) lets (noun phrase)”, and a sentence with capitalized phrase as the subject or object (before or after a verb), etc.

This is illustrated using examples below for some sentence patterns. In the following, underlined parts indicates the part that are extracted, and *** indicates parts that may or may not be present in a sentence, and words inside (xxx) indicate that xxx may or not be present. The IW/P in a sentence is shown in italic. The rule of extraction for a sentence pattern is to extract the part that is underlined.

When the IW/P is in noun form, the sentence patterns and extraction rules are:
*** IW/P *** of *** noun or noun phrase (and noun or noun phrase) Example: The requirement of real-time applications
*** IW/P *** to be *** noun or noun phrase (and noun or noun phrase) Example: The main factor is the weight and height ratio of the baby at the time of birth
*** IW/P *** to be to *** verb *** noun or noun phrase (and noun or noun phrase) Example: The goal of the search is to retrieve relevant information that matches the keywords

When the IW/P is in verb form, the sentence patterns and extraction rules are:
*** IW *** noun or noun phrase (and noun or noun phrase) Example: The machine's performance depends on the machine's design and maintenance history,

When IW is in adjective form, the sentence patterns and extraction rules are:
*** IW/P *** noun or noun phrase Examples: more complex instruction architecture, *** verb *** IW/P *** noun or noun phrase (and noun or noun phrase) Example: . . . removes duplicates and keeps only the very best of the information gathered from queried search engines.

There are also sentences that match multiple of the above forms. In such combination cases, either the union or the intersection of the extraction rules can be applied. For example, in the sentence: “It provides you with the most complete set of search management tools in . . . ” It fits the sentence pattern of “(noun phrase) provides (noun phrase)”, and contains the IW/P “provides” in verb form and the IW/P “most” in adjective form. An intersection of the extraction rule produces “complete set search management tools” as the extracted important concept.

Grouping of Important Concepts

Important concepts can appear in different part of a text, can have different characteristics and importance. One embodiment of this invention divides the extraction of important concepts into groups. Each group has its own extraction rules and ranking. In one embodiment, words extracted from six groups A to F are used as candidate important concepts. Important concepts are selected from these six groups in order according to a pre-assigned percentage. Important concepts selected each group may also have different ranking with group A having the highest ranking.

A. (40%) Extract words in article title and section titles. A title with five or less words can be extracted as a single concept. For example, the title of this section “Grouping of Important Concepts” can be extracted as a single important concept. A title that has more than five words is first broken up into segments by prepositions, connective words and punctuation marks (e.g., in, for, with, by, at, on, and, or, comma, semicolon, etc.). For example, the section title “Indexing Structure for Concept Display, Conceptual Filtering and Concept Path Maps” is broken into 4 segments (Indexing Structure), (Concept Display), (Conceptual Filtering), (Concept Path Maps). Words in the ICEEL are removed from each segment. A first segment with one word is tentatively merged with the segment after it, and if the merged segment has five or less words, the merged segment is extracted as a single concept. If the merged segment has more than 5 words, the two segments are unmerged, and the first segment is tentatively merged with the segment after it. If the merged segment has five or less words, the merged segment is extracted as a single important concept. If the merged segment has more than 5 words, the two segments are unmerged. Each of the remaining segments is extracted as an important concept. In one embodiment, the extracted concepts are ranked by the number of occurrences of the concept in the text with both high and low occurrences given a high rank, by the number of words in an extracted concept with 2- or 3-word concept ranked higher than concept with one or more than three words, and by whether an extracted concept contain search keywords. High and low occurrences can be relative to an average or a pre-specified number. In structured text or in a markup language such as HTML or XML, tags can be used to identify a title or a section title. In the absence of tags or in unstructured text, titles or a section titles can be identified by the fact that it is either in a separate line, or it is a phrase or short line followed with a colon (:). Certain words in titles such as Abstract, Introduction, Background, Discussion, Description, Conclusion, Summary, etc., do not convey any important information on what is in the text, and are thus excluded.

A. (Total 12%, 4% for each group) Extract (a) phrases of 2 to 4 words in which at least 2 words are search keywords, and each different permutation of the search keywords is extracted as a different concept, (b) phrases of 2 to 3 words formed by words immediately before or following one or more search keywords, (c) phrases of 2 to 3 words that are not search keywords, not immediately next to a search keyword and are in the same sentence with one or more search keywords. In one embodiment, the extracted concepts are ranked as below. Concepts extracted from each subgroup are given a subgroup rank between [0, 1] with subgroup (a) having the highest rank of 1. Then, within each subgroup, an extracted concept is ranked by the number of search keywords in the phrase, in the sentence, the number of nouns, and the length of phrase. Each within group rank is normalized to the range of [0, 10]. The ranking of an extracted concept is then computed by a product the subgroup rank and the within group rank.

C. (12%) Extract words in the same sentences with words and their synsets in the Important Word/Phrase List (IW/P List) or in a specified set of sentence patterns using the method described above. In one embodiment, the extracted concepts are ranked as below. The extracted concepts are ranked by a group weight in the range of [0,1] (with group 3 in the IW/P List having the highest rank of 1, group 2 having a rank of 0.6, and group 1 having a rank of 0.3), and by a within group rank normalized to the range of [0, 10]. Then within group rank can be computed based on the frequency of occurrence in the web page or file. In one embodiment, both high occurrence and the low occurring are given high ranking, thus supporting the extraction of both popular and original concepts. One way to do this is by computing the absolute deviation from an average or a pre-specified occurrence number. The ranking of an extracted concept is then computed by a product the subgroup rank and the within group rank.

D. (Total 12%, 4% each) Extract (a). a phrase of two or more words with capitalized first or all letters, the phrase must not cross any punctuation mark; (b). single word with all capitalized letters including acronyms; (c). 2-3 words phrase formed by a first word (excluding the first word of a sentence) with a capitalized first letter together with at lease one noun in the two immediately following words. In one embodiment, the extracted concepts are ranked as below. Concepts extracted from each subgroup are given a subgroup rank between [0, 1] with subgroup (a) having the highest rank of 1. Then within group rank can be computed based on the frequency of occurrence in the web page or file. In one embodiment, both high occurrence and the low occurring are given high ranking, thus supporting the extraction of both popular and original concepts. One way to do this is by computing the absolute deviation from an average or a pre-specified occurrence number. The ranking of an extracted concept is then computed by a product the subgroup rank and the within group rank.

E. (12%) Extract words that are highlighted, bold, italic, underlined, in different color or font. If these words are non-nouns, then include the nouns that follow these words or are the closest to these words afterwards. In one embodiment, the extracted concept are ranked in the order of highlighted, bold, italic, underlined, in different color or font, and by the number of words and the number of the above emphasizing features used on the words. If more than 10% of words in a web page or file are highlighted, bold or italic, underlined or in different font or color, this group can be skipped.

F. (7% for high occurring keywords, 5% for low occurring keywords, but at lease one of each will be extracted) Extract the highest or lowest occurring single-word nouns or phrases of 2 or 3 words (excluding common words) that are not keywords (and not same meaning as keywords). If the highest occurring nouns and phrases are more than 10% of the words in a page or file, do not extract the highest occurring words. If the lowest occurring words or phrases in a file are very common words included in the ICEEL or do not have at least one word that can be a noun, they are not extracted. For the highest occurring noun or phrase, the more times it appears (but no more than 10% of the text), the higher it is ranked. For the lowest occurring noun or phrase, the less time it appears, the higher it is ranked.

Note that in all six groups above, common words in the ICEEL are not extracted and a phrase must not cross any punctuation mark. In one embodiment, concepts that are equal in rank within a group can be either randomly picked or alphabetically picked, whichever requires less processing. The (xx %) after each group letter (A through F) above shows examples of the highest percentages the important concepts extracted from that group will occupy in the total number of concepts to be used for extraction of important concepts for display in the List of Important Concept in 412, 612, 712, or 912, if the total number of concepts extracted from all groups for all web pages or files in the search results exceed a user's choice of the number of important concepts to display. In one embodiment, if a user chooses to display N important concepts, N important concepts extracted from each web page or file will be pooled together with the important concepts extracted from other web pages or files in the search results. Duplicating important concepts and overlapping important concepts can be removed. If an important concept already appeared in a higher ranked group, it can be removed from all lower ranked groups. If two important concepts overlap, i.e., they contain the same words or a part of them have the same meaning, one of them can also be removed. Which one to remove can be decided by preference of a concept in a higher ranking group, and/or preference of a more specific concept (in terms of words, the one with more words) or preference to a general concept (in terms of words, the one with less words). Then, the pool of concepts from all web pages and files in the search results can be ranked, and the top N important concepts can be displayed to the user.

If there are not enough concepts in a category to fill the allotted percentage, the unfilled percentage is pro rata distributed to the remaining category. In one embodiment, each category is guaranteed to have at least one extracted concept included. For example, if a user chooses to display only 10 concepts, and the extraction returned 100 concepts from groups A to F. One highest occurring concept and one lowest occurring concept from group F will be used although it only gets 10% of 10, which is only one concept. In this case, group F will use the allocation from group E if group E has more than one concept allocated to it. Otherwise, the borrowing moves upwards. If N<6, some of the groups, e.g., groups B, D, E, can be ignored.

Extracting concepts in group B requires that the search keywords are known. Assume the search keywords are (wireless networks), then examples of B(a) include (wireless local area networking), (wireless network access point), and examples of B(b) include (wireless connectivity), (cellular wireless), (network security). As can be seen, these can be useful concepts to filter the search results. However, extracting group B concept can only be performed at search time and cannot be processed beforehand because search keywords are not known until search time. To reduce the amount of processing required at search time, important concepts are pre-extracted beforehand for each web page or file. In one embodiment, all important concepts in groups A, C, D, E and F are extracted beforehand, and group B concepts are extracted at search time. Yet in another embodiment, group B concepts are not used, and the percentage assigned to group B is allocated to other groups, e.g., 3% to each of groups C, D, E and F. This eliminates the need to extract important concepts from search results at search time. In the same spirit, the ranking of concepts in group A can be made independent of the search keywords so that they can ranked beforehand to save processing time at search time.

### Extraction of Concepts in Web Search Results Using a Local Computer

As stated, in one embodiment, the tasks of important concept extraction and ranking, and user selectable conceptual filtering and CPM are performed on a search engine server, in another embodiment, they are performed on a user's local computer, in yet another embodiment, they are performed partly on a search engine server and partly on a user's local computer. When they are performed on a user's local computer, a local download program needs to download the web pages and files listed in the search results returned from a search engine. The user's local computer can ten perform the tasks of important concept extraction and ranking by analyzing the downloaded web pages and files. Since downloading and important concept extraction and ranking can take some time, in order to display the List of Important Concepts and other filtering features to a user in a short time, in one embodiment, these tasks are performed progressively, meaning that partial results of downloading and extracting important concepts and other filtering features are displayed to the user while the program continue to download web pages or files listed in the search results and to periodically update the List of Important Concepts and relevancy ranking when extraction and ranking of important concepts and other filtering features from the newly downloaded web pages and files are completed. For example, at the beginning, the first 50, or less if the search results are less than 50, web pages or files in the search results are downloaded, and the results of extraction and ranking of important concepts and other filtering features applied to these pages or files are displayed to the user as the programs of this invention running on the user's PC continue to download and analyze. In one embodiment, the programs of this invention estimate or monitor the time needed for download and analyze the first 50 results. When a set threshold is reached, e.g., 5 seconds, the programs of this invention display what partial results are available at that time. Also, to avoid long delays, in the first 1 or 2 batches of download, large pages or files, e.g., larger than 100 KB, are not downloaded, their download is scheduled to a later batch so that the user can start viewing the analysis results quickly. In addition, since the tasks of information mining and analysis for extracting important concepts, sources and other filtering features are performed on the texts, graphs and images in a web page are not downloaded to save download time. However, textual annotations and other textual information about graphics and images are downloaded and included in the information mining and analysis, same as other texts in the page. In one embodiment, after the first M web pages or files have been downloaded, large web pages and files, e.g., those that are larger than 100 KB, that are skipped initially are downloaded sequentially, so are subsequent large web pages and files.

In one embodiment, when a user visits a search engine 500 of his choice, clicks the “Enable DIGGOL” button 503 to enable the functions of this invention (this step is not needed if the functions of this invention is already enabled by default), and after the user enters search keyword string into 507 and clicks the “Search” button 509, programs of this invention perform downloading, important concept extraction and ranking progressively, and displays partial concept extraction results and other filtering features to a user in 612 and 616 in less than 5 seconds. As programs of this invention download more each search results, extract important concepts from them, and add the newly extracted concepts to the total pool of important concepts from the search results. Duplicates and subset concepts are removed, and the remaining important concepts in the pool are re-ranked. Then, the List of Important Concepts is updated based on the new pool of important concepts and ranking results.

To extract information from web pages or files ranked low by a search engine, which a user normally may not read, in one embodiment, programs of this invention download and analyze the web pages or files from both ends of each batch of results, meaning that if the first 50 results are to be downloaded and analyzed, the sequence of downloading and extracting important concepts and other filtering features are performed in this order: 1, 50, 2, 49, 3, 48, . . . etc. In subsequent downloads or when downloaded results are different than 50, the same process is applied. This is referred to as the process of “burning a candle from both ends”. The rational is that higher ranked results contain popular views while lower ranked results are ranked low possibly due to they are new, or not widely recognized, or unique, etc., thus may contain useful information. Ranking methods of this invention, described later, also uses the same principle and rank high both extracted important concepts that are most popular and extracted important concepts that are least popular, thus, unique. The process of “burning a candle from both ends” and the ranking methods of this invention enable important concepts contained in lowly ranked search results to be shown to a user early if they are ranked high enough, together with the important concepts contained in highly ranked search results. Prior art search engines do not have this capability.

To inform a user of the progress of the ongoing operation of the programs of this invention, in one embodiment, a progress bar is shown at the bottom of the browser window. The progress bar shows how many web pages or files out of the total number search results have been analyzed, e.g., in the format of “1,250 pages out of 223,588 pages have been analyzed”.

To further reduce the processing time for extraction and ranking of important concepts and other filtering features, in one embodiment, if the web page or file is a large text document, e.g., with more than 5,000 words, in a first run, important concepts extraction is only perform on sections of abstract, discussion, conclusion, and summary, and on the first and last section of the document, and on the first one or two sentence and the last one or two sentences of each paragraph. In another embodiment, important concepts extraction is first performed on a large document with the above restriction, and the extraction continues to work at a later time for the rest of the web page or file. Any new important concept that is extracted at this later time is added to the pool of all extracted important concepts.

In one embodiment, to avoid a user waiting, the web search results as returned by the search engine are displayed in 650 first when the interface 600 is first opened. The List of Important Concepts in 612 and other filtering features 616 for the web search results are filled in as they become available. The ranking of the web search results may also be changed as results of relevancy ranking by methods of this invention become available. On the other hand, important concepts, filtering features and relevancy ranking of hard drive search results are available in a very short time because extraction and indexing have been performed on files in the local computer beforehand.

Often when only a part of web search results are downloaded and important concept are being extracted from them, a user may start clicking on a search result to read a web page or file at the URL returned by the search engine in 408 or 621, or clicking “Next” button 470 or 670 to move to the next page of search results, or selecting or excluding concepts in the List of Important Concepts in 412 or 612 to perform conceptual filtering. In these cases, the List of Important Concepts is also a work in progress. In such cases, in the background, the programs of this invention can continue to download search results from the original web search, to extract important concepts from the downloaded web pages or files, to update the List of Important Concept, and to filter the original web search result according the user's selection or exclusion of concepts in the List of Important Concepts. When a user clicks on a link returned by the search engine to view a web page or file in 408 or 621, if the web page or file has been or is being downloaded by the download program of this invention, the downloaded version save on the hard drive or the web page or file currently being download can be provided to the user interface program to display in 408 or 621. When a user clicks on a link returned by the search engine to view a web page or file in 408 or 621, if the web page or file has not been downloaded by the download program of this invention, the web page or file is downloaded directly from the URL returned by the search engine, and saved into the set of downloaded web pages or files for extraction of important concepts and other filtering features. In one embodiment, when a user clicks on a link returned by the search engine to view a web page or file in 408 or 621, that web page or file is moved to the front of the queue for extraction of important concepts and other filtering features. In another embodiment, when a user clicks on a link returned by the search engine to view a web page in 408 or 621, if the download program only downloaded the textual part of the web page, either the full web page or the graphics portion of it is downloaded directly from the URL returned by the search engine, regardless whether the web page has been downloaded by the download program of this invention so that the full page with graphics can be displayed to the user.

Often, a web search by keyword(s) returns a very large number of search results. In an embodiment where important concepts have been pre-extracted from all web pages and files and indexed at the search engine, important concepts from all web pages and files in the search results can be made available for ranking and listing in the List of Important Concepts. However, in an embodiment where extraction and index of important concepts in web search results are performed at a user's PC, web pages and files that are ranked low by a search engine are at the back of the list of search results and would not get downloaded and analyzed for a long time. For example, web pages and files listed as 999,901 to 1,000,000 on page 100,000 of the list search results would not be downloaded if the downloading program downloads the search results in the order of the search engine listing. In one embodiment, an option is offered to a user to choose what portion of the search results should be downloaded and analyzed first. In the first 1,000 web pages and files to be downloaded and analyzed, it shall allow a user to select percentages to be downloaded from the top, anywhere in the middle, and the bottom of the list of search results returned by a search engine. Search results buried in the middle or at the bottom of the search engine ranking list may be ranked low by a search engine due to low link popularity or because they are new. They may contain new and relevant results. Downloading and analyzing them first allows a user to get a quick preview of the important concepts contained in these search results. These search results would typically not be viewed by users using prior art search engines. Also, when downloading search results for analysis and concept extraction, to save disk space, a user can choose to download and save M, e.g., 1,000, web pages or files. By saving M search results, a user can quickly view them without waiting for download. When a user has a large free disk space, he can set to save more downloaded pages. Downloaded web pages and files beyond the M web pages or files are deleted after analysis and concept extraction. A user can also set the number of MBs that can be used to save downloaded results. When the downloaded results exceed the set MB limit, future downloads are deleted after analysis and concept extraction. A default can be set to 100 MB. In one embodiment, an option is offered to a user to choose a first set of rules in deciding what downloaded files shall be kept in the allocated disk space. One example is any file larger than 0.5 MB. This way, large web pages or files are saved for a user to view instantly later without waiting for downloading. Smaller web pages and files are not saved since they can be quickly downloaded when a user wants to view it. When more web pages and files are downloaded, the space occupied by web pages and files that do not meet the first set of rules for saving downloads are overwritten to limit the amount of disk space required.

### Relevancy Ranking of Concepts and Conceptually Filtered Search Results

This invention makes use of natural language processing to compute the ranking of a search result based on its relevancy to the search keyword string. It improves prior art relevancy ranking methods. In one embodiment, content-based relevancy ranking of this invention is combined with search engine ranking, e.g., Google PageRank based on voting or popularity in a weighted average to produce a new ranking.

Relevancy Ranking of a Search Result

Each search result can be ranked using its link popularity, or if a prior art search engine is used, it has a ranking by a search engine, e.g., Google or Yahoo. Popularity based ranking, e.g, Google's PageRank, and other prior art search engine rankings are weak on relevancy.

When a user searches with two or more keywords, he is typically interested in search results where these keywords are related and appear in the same article. In prior art search engines, often when a user searches with two or more keywords, web pages in which the keywords appear in different frames or in totally unrelated parts on the web page are retrieved as search results. In another example, when a user search for an exact phrase, e.g., “price change”, prior art search engines often return search results in which the words in the phrase are separated by punctuation marks, e.g., “ . . . fixed price. Change of address . . . . ”. In this example, the two words price and change are together but they are unrelated and irrelevant to what the user is interested.

Often the creation or modification date of a web page or file or article is also a useful relevancy rank because a user may be interested in the most up to date information or information in a specific date range. In one embodiment, a weighted average of a content-based relevancy rank, a date rank and a link based ranking is used to produce a new Page Rank as shown below:

Page Rank of search result i=PR(i)=a*Link Based Rank+b*Relevancy Rank+c*Date Rank where a, b and c are positive numbers with a+b+c=1, and represent the weight placed on Link Based Rank, Relevancy Rank and Date Rank (DR). In one example, a=b=0.4, c=0.2. The highest Link Based Rank is assumed to be 10. When c≠0, the default date rank can be computed by:

$$Default DR = \{ \begin{matrix}10 , & if t \leq 1 week \\ 8.5 , & if t \leq 1 month \\ 6 & if t \leq 3 months \\ 5 & if t \leq 1 year \\ 4 & otherwise\end{matrix} \\ Selected DR = \{ \begin{matrix}10 , & if t \text{is in selected date range} \\ 8 , & if t \leq 1 \text{month from selected date range} \\ 6 & if t \leq 3 \text{months from selected date range} \\ 4 & if t \leq 1 \text{year from selected date range} \\ 2 & otherwise\end{matrix}$$

where t is date the web page or file was created or modified. The Default Date Rank is used when a user did not select a date range in the left pane 416 or 616. When a user selects a date range in the left pane 416 or 616, the Selected Date Rank is used.

The Relevancy Rank is calculated by:
1. Each keyword entered by a user or its variants (i.e., variations of the root word) carries 10/N point. If a keyword is expanded into a concept, a word in a synset of a keyword carries 9/N, a word that is a hyponym or troponym of a keyword carries 9/N, and a hypernym of a keyword carries 7/N, where N is the total number of keywords a user enters into a search box.
2. Relevancy Rank=(R1+R2)/(10N−1), where R1=10*P1*P2 where P1=(number of two keywords next to each other in exact order as entered by the user), and P2=sum(points of these words), and R2=max {max _{all sentences}[9*Σ (points of keywords in the same sentence, not cross comma or return)], max _{all sentences}[8*Σ (points of keywords in the same sentence, not cross period or semicolon or return)], max _{all sentences}[6*Σ (points of keywords in the same paragraph)], max _{all sentences}[5*Σ (points of keywords in adjacent paragraphs)], max _{all sentences}[4*Σ (points of keywords in same section)], max _{all sentences}[3*Σ (points of keywords in same frame of the page)]}, and (10N−1) is a normalization factor.

In R1, when M keywords, where M>2 is a positive integer, appear next to each other in exact order as entered by the user, the term P1=M−1. For example: if a user enters the keyword string (wireless network security), and the following 2-word phrases are found in a web page (wireless networks) (network security), then P1=2. If the web page contains the 3-word phrase (wireless network security), P1=2 also because (wireless network) is counted as two keywords together, and (network security) is also counted as two keywords together. In one embodiment, how many times a phrase, e.g., (wireless networks) and (network security), appear in the web page is not counted. Each phrase is counted only once. If the user search using a single keyword, P1=0, P2=90, and R2=9*10/(10*1−1)=10.

To save computation, once all 2-word phrases of the search keywords are found, R1=10*(N−1)*10 and reaches the highest possible value. The important concept extraction and ranking program stops searching the text for computing R1. Similarly, once a sentence that contains all the keywords is found, the program no longer searches the text for computing R2. Example, the user enters (wireless network security platform implementation), if the program already found the following phrases (wireless network security), (security platform) and (platform implementation), it stops searching the text for computing the R1 since P1=4 and R1=10*4*10 reaches the highest possible value. If all these phrases are in the same sentence, not crossing a comma, it stops searching the text for computing R2 as well since R2=9*10 also reaches the highest value. In this example, the relevancy rank is (400+90)/(10*5−1)=10. This definition of the relevancy rank makes it likely that in many cases, only a part of a text needs to be scanned to compute the relevancy rank of a web page or file.

In one embodiment, the Link Based Rank term of a first web page is computed as a function of the number and types of links pointing to the first web page, and the Link Based Ranks of the web pages linking to the first web page. In another embodiment where the web search is carried out by a prior art search engine, the Link Based Rank term is substituted by the ranking of the search engine, e.g., Google or Yahoo, or by a function of the ranking of the search engine. In the search of files in a hard drive of a local computer which have no or limited hyperlinks, the Link Based Ranking term is assumed to 10 for all files. Alternatively, it is assumed to be 0 and the weight of the Relevancy Rank term is increased to 1.

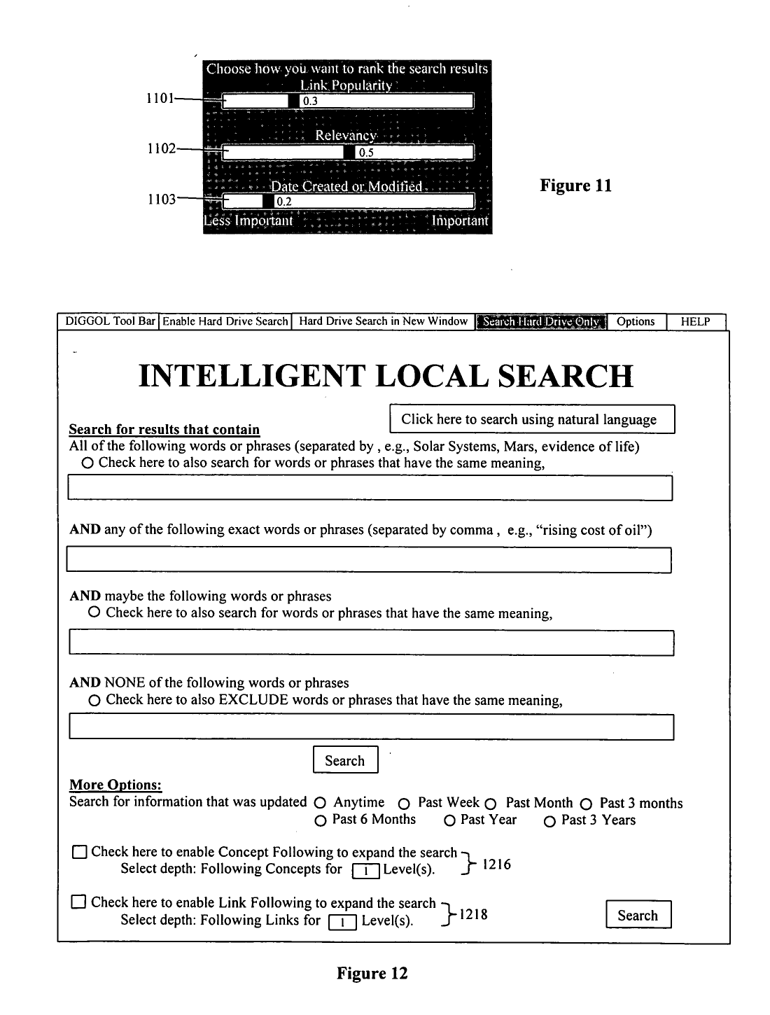

A user may want to adjust the weights given to the three factors in Page Rank formula. For example, a user may be more interested in web pages with high Relevancy Rank that are most recent, and has less interest in the Link Based Rank because it is exploited by link farms or link exchanges, then he may want to select a weight vector of (a, b, c)=(0.2, 0.5, 0.3). In one embodiment, an adjustable 3-bar interface is provided to a user for the user to adjust the weight put on to each ranking term, as shown in FIG. 11. In one embodiment, a user can only adjust two bars, e.g., Link Popularity 1101 and Relevancy 1102, and the third bar, in this example, Date Created or Modified 1103 is computed by a ranking weight vector program of this invention so that the three numbers sum to 1. In another embodiment, a user is allowed to adjust all three bars, but the ranking weight vector program of this invention normalizes the three values chosen by a user so that the three numbers sum to 1.

As an extension to the relevancy that takes into consideration of the order of appearance of the keywords in a text, in one embodiment, a search program can support a “same order” search mode that retrieves a web page or file if it contains words that are from the search keywords, and that they appear next to each other and are in the same order in the search keywords as entered by a user. It may further support search modes that only retrieve such results if there is no punctuation marks added between these words. An example is the “price change” search mentioned at the beginning of this subsection. In another embodiment, only the order of appearance is considered, and additional words or texts are allowed between such words.

Selection of Extracted Concepts from Individual Pages or Files and from Collection of Search Results

For each web page or file, the extracted important concepts, grouped into groups A to F, are ranked within each group, and can be selected according to a percentage allocation as described previously. The extraction, ranking and selection of the important concepts in a web page or file are described in the previous sections. If a user selects to show N important concepts in the List of Important Concepts 412, 612, 712, or 912, the important concept extraction and ranking program of this invention selects up to N top ranked important concepts in each web page or file from a set of web pages and files in the search results. This set, referred to as the Extraction Set, may be all the web pages and files in the search results, or may be a subset of all the web pages and files in the search results. The Extraction Set is a subset if the important concept extraction and ranking program performs the extraction for only a pre-specified or pre-selected part of the web pages and files in the search results. It can be a subset if a user chooses to stop the important concept extraction and ranking program before it could complete extraction and ranking of all the web pages and files in the search results. It can also be a subset if the important concept extraction and ranking program is still ongoing and has not finished extracting and ranking important concepts from all web pages and files. In this case, the Extraction Set continues to grow as the important concept extraction and ranking program completes extraction and ranking of more web pages and files. If N>6, at least one extracted important concept from each of the A to F group for a web page or file is selected. If N<6, some of the groups, e.g., B, D, E, can be ignored. Then, the selected up to N important concepts from each web page or file in the Extraction Set are collected into an Extracted Concept Pool. Duplicates and subset concepts are removed from this pool of important concepts, as described before. Then, the extracted important concepts in the Extracted Concept Pool are ranked. In one embodiment, the ranking is calculated by the following formula:
Concept Rank of concept j=CR(j)=c*10*max{Na(j), (Nt−Na(j))}/Nt+d*{Σ_{All pages containing concept j} PR(k)}/Na(j)
where c>0, d>0, c+d=1, Nt is the total number of web pages or files in the Extraction Set at the time when CR(j) is being computed, and Na(j) is the number of web pages and files in the Extraction Set that contain concept j. Note that Na(j)>0 because at least one web page or file must contain the concept for it to be included in the Extracted Concept Pool. Also note that the maximum of CR(j) is 10 for any concept. This ranking formula ranks high both very popular concepts MPCs and very rare concepts MOCs. This is useful because the MPCs and MOCs are very likely to contain more information than those in the middle. The MOCs are those that most search results believe that they are important, therefore, are likely to be important. This is similar to how prior art search engines such as Google's PageRank algorithm ranks search results. On the other hand, the MOCs are those that only a small number of search results notice that they are important. Therefore, they are most different from the popular view. Often, discovery is made by noticing what the masses are not paying attention to, by going down a path other than the beaten path. Thus, the rarest concepts are likely to be important, and this invention ranks them higher. In contrast, they are buried behind a large number of popular concepts in prior search techniques, which have failed to rank such likely concepts high enough for users to see them. The weight factor c represent the weight placed on the popularity or rarity of a concept vs. the weight d placed on the average page rank of the web pages and files containing the concept. In one example, c=d=0.5.

In one embodiment, the important concept extraction and ranking program may provide a user interface for a user to select two positive integer numbers A and B, where A+B=N, such that A MPCs and B MOCs are selected for display in the List of Important Concepts 412, 612 or 712, and N is the total number of important concepts to be listed in the List of Important Concepts. The ranking of MPCs and MOCs can be computed by:
MPC Rank of concept j=CR(j)=c*10*Na(j)/Nt+d*{Σ_{All pages containing concept j} PR(k)}/Na(j)
MOC Rank of concept j=CR(j)=c*10*(Nt−Na(j))/Nt+d*{Σ_{All pages containing concept j} PR(k)}/Na(j)
Computation of Relevancy Rank and Concept Rank at Search Time

The computation of the Relevancy Rank requires knowing the search keyword(s) used for the search, thus can only be computed at search time. In the six groups of important concept extractions, groups A, C, D, E and F can be extracted beforehand, but group B can only be extracted at search time because it needs the knowledge of the search keyword(s) used for the search. In pre-processing, important concepts in groups A, C, D, E and F can be extracted, the indexes B_{SE} and C_{SE}, or B_{IP} and C_{IP}, or B_{PC} and C_{PC} can be built for these extracted important concepts. Computations of Page Rank PR and Concept Rank CR are computed at search time.

After a new search, when a user performs conceptual filtering by select extracted important concept(s) in the List of Important Concepts, it is equivalent to a search with the selected important concepts as additional search keyword(s). Thus, Relevancy Rank and Page Rank PR need to be re-computed. In one embodiment, to reduce the amount of processing required for conceptual filtering so that filtering results can be instantly displayed to a user, the Relevancy Rank and Page Rank PR are computed only once when a new search is conducted, and the same Relevancy Rank and Page Rank PR from the original search are used for the ranking of the filtered results. In one embodiment, the Concept Rank CR is re-computed based on the filtered results, and the List of Important Concepts is updated according to this new ranking. In another embodiment, to further reduce processing time for conceptual filtering, both the Concept Rank CR and the List of Important Concepts are not changed and remain the same as the original search. In yet another embodiment, a user is given the option to choose which one of the above two embodiments to be executed. In one embodiment, only important concepts in groups A, C, D, E and F are extracted, and important concepts in group B are not extracted. This way, all extraction of important concepts can be performed beforehand, thus eliminating the need to extract important concepts at search time. It further reduces the amount of processing at search time.

As described before, extraction of important concepts, conceptual filtering and CPM can be carried out either in a search engine server, or in a user's PC, or with part of the tasks carried out in each. Similarly, the computation of Relevancy Rank, Page Rank PR and Concept Rank can be computed either in a search engine server, or in a user's PC, or with part of the tasks carried out in each. Computing at a user's PC makes use of the massive processing power of millions of PCs on the Internet, rather than depending on the search engine server to centrally processing requests from many users, which may be tens or hundreds of millions at a given time, requiring a massive computer or a massive server farm at the search engine.

In one embodiment, when the index C_{SE}, or C_{IP}, or C_{PC} is first built before a search is conducted, each entry of the index maps a web page or file to a list of all the important concepts extracted from the web page or file, except important concepts that can only be extracted when the search keyword(s) is known, e.g., group B concepts. The number of important concepts in the list can be subject to a maximum, e.g., 100, with a percentage distribution to each group as described previously. The percentage allocated to group B can be reserved for search time. The important concepts in this list can be ranked within each group. For group A, the ranking component dependent on the search keyword(s) can be ignored at this time. This ranked list of important concepts in the entry of the index C_{SE}, or C_{IP}, or C_{PC} for each web page or file is referred to as the Pre-Search Ranked List (PSRL). At search time, the search keyword(s) is known, thus, group B concepts can be extracted and ranked, and group A concept can be re-ranked. The PSRL in the entry of the index C_{SE}, or C_{IP}, or C_{PC} for each web page or file is modified to produce a Search Time Ranked List (STRL). When selecting N concepts for listing in the List of Important Concepts in 412 or 612, the top ranked concepts in each group in the STRL is selected according to the percentage allocation described previously, up to a maximum of N concepts total from the web page or file. The N concepts from each web page or file are pooled together. Duplicate and subset concepts are removed and Concept Rank CR is computed for the remaining concepts. The top ranked N concept from this pool is listed in the List of Important Concepts in 412 or 612. In another embodiment, to reduce processing time, top ranked concepts in each concept group of a web page or file is directly selected from the PSRL entry of the web page or file in the index C_{SE}, or C_{IP}, or C_{PC}, without extracting group B concepts and without re-computing the group A concept ranking.

The embodiments of relevancy ranking of search results provide a new method for compute a rank of a file in the results of a search, comprising, as shown in FIG. 19, identifying in the file one or more matching elements that are considered identical, equivalent or similar to part or all the description that defines the search as entered by a user (1902); computing a relevancy ranking factor based on one or more of the following in the file (1904):

The degree of identicalness, equivalence or similarity of the one or more matching elements to their counterparts in the description that defines the search; the order of appearance of two or more matching elements compared with the order of appearance of their counterparts in the description that defines the search; the relative position of two or more matching elements in a sentence or text structure; the presence or absence of punctuation marks or other symbols between two or more matching elements; the format in which one or more matching elements appear; the role of one or more matching elements in the file; the location or part of the file in which one or more matching elements appear; and, the presence or absence of information that are similar to information that is specific to a user and the degree of the similarity. In this method, part or all of the ranking computation may be carried out in a user's local computer.

The embodiments for ranking concepts provide a new method for searching information, comprising, as shown in FIG. 17, obtaining one or more information elements extracted from a first set of one or more files or parts thereof (1702); ranking the one or more information elements based on one or more of the following ranking parameters (1704): a function of a link-based popularity rankings of the files from which an information element is extracted; a function of a relevancy rankings of the files from which an information element is extracted; a function of a date-based rankings of the files from which an information element is extracted; ranking an information element higher if it can be extracted from more number of files, ranking an information element higher if it can be extracted from less number of files; format of an information element; relation of one or more information elements relative to one or more information elements in a second set of information elements; location or roles of one or more information elements in the text; context in which one or more information elements appear; and the semantics of one or more information elements.

In the above method, the first set in 1702 may be the results of a first search that is defined by one or more descriptions of the first search, and the second set of information elements may be one or more of the following: important words and/or phrases; sentence patterns; concepts or semantic meanings; and statements. The method may further provide a user interface and allow a user to adjust the weight of one or more ranking parameters.

### Search of Files in Local Computer's Hard Drive(s)

In one embodiment, the user interface offers a user an option to search the files in the hard drive of the user's local computer, as shown in the browser tool bar option “Enable Hard Drive Search” as shown in FIGS. 1, 3-7 and 9. This integrates the web search and search for files in a user's local computer in the same browser interface familiar to users. In one embodiment, web search results and local computer hard drive search results are shown in the same window as shown in FIGS. 4 and 6. In another embodiment, an option is offered to a user to show the hard drive search results in a separate browser window as shown in FIG. 7, by clicking a “Hard Drive Search in New Window” button 430 or 630, so that there is sufficient space to show all results details. In one embodiment, when a user searches the web, searching the PC's hard drive is included only when a user choose it using the “Enable Hard Drive Search” option. On the other hand, when a user chooses to only search files in his local computer by clicking the “Search Hard Drive Only,” the search keyword(s) and any other information are not transmitted to a search engine.

The hard drive search program builds beforehand the indexes A_{PC}, B_{PC} and C_{PC}. The use and relationships among the three indexes are shown in FIG. 10. The index A_{PC} is indexed by keywords and maps a keyword to a list of files containing the keyword. When queried with a keyword it returns the name and path of file(s) containing the keyword. This index is used for searching files using keywords. The keywords in A_{PC} are extracted from the file names, text fields of a file's properties (e.g., as shown in the Properties field of a file when you right click on the file name in a Windows PC), and texts within files. The search program can index the textual contents of files with textual contents, e.g., email files, image files, audio and video files, program files, and various applications files like Microsoft Word, Excel, Power Point, Adobe pdf, txt, html, etc.

The index B_{PC} is indexed by the important concepts extracted from files in the hard drive and maps an extracted important concept to list of names and paths of files from which the important concept is extracted. When queried by an extracted important concept, e.g., when performing conceptual filtering when concept(s) in the List of Important Concepts is selected and for generating CPM, it returns the list of names and paths of files from which the important concept is extracted. Similarly, a FTFI is also built for each filtering features listed in 716. When queried by a filtering feature, it returns the list of names and paths of files that contain the filtering feature.

The index C_{PC} is indexed by file name and path and maps a file to a list of important concepts that are extracted from the file. When queried by file name and path, e.g., when retrieving and selecting N important concepts from the files in the search results, and when displaying concepts contained in a file when the cursor floats on top of the file name, it returns a ranked list of important concepts extracted from the file. These three indexes may be organized in one file or in separate files. Similarly, the other filtering features in 416 or 616, e.g., files types, date ranges, etc., can be extracted from the search results, and indexes can be built so that filtering by these features can be processed quickly.

To provide hard drive search results and user selectable conceptual filtering and mapping quickly, the hard drive search program performs extraction and ranking of important concepts from each file, extraction of other filtering features, and builds the indexes beforehand. When the hard drive search program is first installed, it performs these tasks in the background. To inform a user the progress, a progress bar can be shown, e.g., at the bottom in or above the Window tool bar. The progress bar will show how many files out of the total number of files have been indexed and analyzed. The format is “925 files out of 923,588 files have been indexed & analyzed”. After all files have been indexed, it informs the user that the program is ready to perform instant search and analysis of files on the PC's hard drive. If the PC is turned off or the program is interrupted by other means, the program can be automatically resumed from where it was stopped the next time the PC is turned on or brought into active state from stand-by or hibernation.

When new files are added to the hard drive, the indexing, extraction and ranking of important concepts, and extraction of other filtering features can be done automatically for the new files. The new results are added to the indexes. This updating can be done periodically, and the period interval for updating the index can be selected by user using the Options button in the browser tool bar. The default period interval for updating the index can be set to every day or every week at a certain 10:00 pm if the computer is on, or when the computer is turned on and idle the following day.

After the indexes are built, hard drive search results can be quickly retrieved using the A_{PC} index, and the extracted important concepts can be quickly retrieved from the C_{PC} index. Therefore, the search results and top ranked important concepts in the search results can be shown very quickly in 721 and 712, as a user enters search keywords. Also, when the cursor floats on top of a file name in the hard drive search results pane, the important concepts extracted from the file can be quickly retrieved from the C_{PC} index and shown in a small window. When the cursor moves away from the file name, the small window will disappear. When the file name is doubled clicked, the file can be opened by launching the corresponding application. When a user selects or excludes concepts in the List of Important Concepts, and/or other filtering features, filtered results can be quickly retrieved using the C_{PC} index and the FTFI for the selected features.

In one embodiment, when a user clicks on the date, file name, folder, or date fields 752, the local control program changes the hard drive search results display to sort the results by descending or ascending order of the clicked field. This makes the interface behave similar to the Windows environment that users are used to. In another embodiment, if the local computer is not connected to the Internet, and a user performs a search, the search is automatically interpreted and carried out as a hard drive only search.

When the local computer is connected to the Internet, this invention also offers a user the choice to search hard drive only and not to perform web search by clicking the “Search Hard Drive Only” button. When a user clicks the “Search Hard Drive Only” button, the local control program invokes the hard drive search program, instructs it to search the hard drive only and not to submit the search keywords or NLDS the user entered to any search engine or computer over a network. This is useful when a user wants to perform a confidential search of files in the local computer and does not want the search keywords to be sent to a search engine. The results of the “Search Hard Drive Only” search are displayed in a browser window with a left pane showing List of Important Concepts and other filtering features, and second pane showing the results of searching the PC's hard drive as in FIG. 7. In one embodiment, when the “Search Hard Drive Only” button is clicked, the local control program brings up an html page residing in the user's local computer. In one embodiment, it presents to a user an interface shown in FIG. 5, similar to a prior art search engine interface, but the keywords entered are only used to search files in the user's local computer. In another embodiment, an improved search interface of this invention as shown in FIG. 12 is presented to a user that offers the new features of this invention, including expansion of keywords into concepts, “Maybe Words,” concept and link following. In another embodiment, when a local computer is connected to the Internet, a hard drive search and a web search can be conducted simultaneously, but the two searches are independent, each with its own text box for entering search keyword(s).

Hard drive search that are fast makes it easy for anyone to find information on a computer. An unauthorized user can quickly find private information in a user's computer. All he needs is a few seconds of time when the computer is unattended. Therefore, there is a need protect against the breach of private information stored in a computer from a fast hard drive search.

In one embodiment, the hard drive search program requires a password or another method of authentication of a user for it to conduct a search of any information stored in the hard drive(s) of or connected to a computer. In another embodiment, a password or another method of authentication of a user is required only for searching information of one or more specified hard drive(s) or hard drive partition(s) or folder(s) or file(s). If a user enters the correct password or authentication, the hard drive search program returns search results from both the specified hard drive(s) or hard drive partition(s) or folder(s) or file(s) that are protected by the password or authentication, and the other unprotected hard drive(s) or hard drive partition(s) or folder(s) or file(s). Otherwise, the hard drive search program returns search results only from the unprotected hard drive(s) or hard drive partition(s) or folder(s) or file(s). In yet another embodiment, the hard drive search program requires a password or authentication requirement specific to each specified hard drive or hard drive partition or folder for it to return search results from each of the specified hard drives or hard drive partitions or folders. In yet another embodiment, the hard drive search program requires a password or authentication specific to each specified hard drive or hard drive partition or folder, however, there is a master password or authentication. Once the master password is entered or the master authentication is successful, the hard drive search program will return search results from all unprotected and protected hard drives or hard drive partitions or folders.

In one embodiment, a protection data file or a protection database is used to store all the hard drive(s) or hard drive partition(s) or folder(s) or file(s). The hard drive search program or the file protection program refers to the database to determine if a password or a means of authentication of the user is required to perform a search, or display a search result, or open file, modify a file, print a file, or perform an action on the file. The hard drive search program or the file protection program can have an interface for a user to add, edit or delete hard drive(s) or hard drive partition(s) or folder(s) or file(s) in the protection data file or protection database. In one embodiment, after a hard drive search, the hard drive search program asks whether a user want to protect any hard drive(s) or hard drive partition(s) or folder(s) or file(s). If the user chooses to protect any hard drive(s) or hard drive partition(s) or folder(s) or file(s), they are added to the protection data file or protection database.

In some cases, a user is interested in protecting searching for specific information on his computer. In one embodiment, the hard drive search program requires a password or authentication method when a user searches information using certain word(s) or phrase(s) or sentence(s) or concept(s), or when displaying a file in search results that contains certain word(s) or phrase(s) or sentence(s) or concept(s) in its file name, file type, properties, authors, textual contents, or other textual characteristics (collectively referred to as contents). In another embodiment, this method of protecting a file by its contents is further extended to a file protection program that protects a file based on its contents from other operations on the file. In this extended embodiment, if a file contains certain word(s) or phrase(s) or sentence(s) or concepts in its file name, file type, properties, textual contents, or other textual characteristics that match at least one rule, the file protection program requires a password or a means of authentication of a user in order to open the file, or to modify the file, or to print the file, or to perform an action on the file.

In one embodiment, a protection data file or a protection database is used to store all the words, phrases, sentences, concepts, and rules. The hard drive search program or the file protection program refers to the database to determine if a password or a means of authentication of the user is required to perform a search, or display a search result, or open file, modify a file, print a file, or perform an action on the file. The hard drive search program or the file protection program can have an interface for a user to add, edit or delete words, phrases, sentences, concepts, and rules in the protection data file or protection database. In one embodiment, after a hard drive search, the said interface asks whether a user want to protect this search. If the user chooses to protect this search, the keyword(s) used in this hard drive search is added to the protection data file or protection database.

In another embodiment, the hard drive search program or the file protection program can expand the words or phrases in the protection file or protection database to concept, i.e., to expand a word or phrase to include its synsets, hypemyms, and hyponyms/troponyms, in a manner similar to the keyword to concept expansion methods described in a previous section of this invention.

In all the above embodiments for protecting information from hard drive search by an unauthorized user, the hard drive search program may require a password or authentication of a user before it searches specific hard drive(s) or hard drive partition(s) or folder(s), or keyword(s) or concept(s). Alternatively, the hard drive search program may search all hard drive(s), including the protected hard drive(s) or hard drive partition(s) or folder(s), or search using the protected keyword(s) or concept(s), without requiring a password or authentication. After the search, if any file is retrieved from the protected hard drive(s) or hard drive partition(s) or folder(s), or if any file is retrieved from searching using the protected keyword(s) or concept(s), then the hard drive search program requires a password or authentication of a user before it displays files that contain the protected keyword(s) or concept(s). If a user does not enter a password or authentication, the hard drive search program simply returns no results from the protected hard drive(s) or hard drive partition(s) or folder(s), or returns no files that contain the protected keyword(s) or concept(s).

The embodiments of protecting information based on contents provide a new method to protect information, comprising, as shown in FIG. 21, maintaining a first set of one or more characteristics or information elements of one or more files or parts thereof or descriptions of contents that are to be protected (2102); requiring a user to pass one or more security measures before allowing the user access to a second set of one or more files or parts thereof that match or contain some or all the information in the first set (2104). This method may further check one or more files and mark the files that match or contain some or all the information in the first set, the marked files are included in the second set. In addition, the first set may further include one or more rules on what types of operations can be performed on files containing one or more characteristics or information elements or descriptions of contents specified in the first set.

In step 2104 of this method, allowing a user access to a second set of one or more files or parts thereof may comprise performing a search for a user. The method may further compare the description of the search provided by the user with the first set to decide whether one or more security measures are required before performing the search.

### Link and Concept Following

To achieve broad and accurate search on the Internet using a prior art search engine, a user often needs to spend hours in front of a computer. He needs to follow links in web pages or files found in search results using original search keyword(s), search using new keywords found in web pages or files in search results using original search keyword(s), and wait for download of large files. This invention automates this search process by automatically identify links and important keywords or concepts to follow, automatically following them and automatically download large files to a user's computer, without requiring user interaction. This expands the scope of a search to retrieve potentially useful information that may be missed by prior art search engines. The search results from the expanded search can be analyzed, extracted, ranked, organized, filtered and visualized using the methods of this invention. Thus, this invention both expands the scope of a search by retrieving more information covering a broader range, and provides analysis and visualization tools for a user to dig useful information out of the large amount of information. At the same time, many of the surfing tasks are automated, saving a user's time and increasing his productivity. All these can be carried out in the background while a user is working on something else or reading a web page.

In one embodiment, an automated surfing program provides a user interface for a user to choose the depth of concept following and the of depth link following, as in 116 and 118, or 316 and 318, or 1216 and 1218. Assume that a user enters the original search keyword(s) and selects a depth of D in concept or link following. The automated surfing program first retrieves web search results using the original search keyword(s). It then extracts up to K top important concepts or important links from each web page or file in the order the search results are ranked by the search engine or a user selected ranking formula, with the important concepts or important links extracted from the highest ranked web page or file first. The parameter K is a positive integer and can be set by default or chosen by a user. The important concepts or important links may be pre-extracted and ranked at the search engine before the search, or extracted and ranked at a user's local computer by downloading and analyzing the web search results, or extracted and ranked by a combination of pre-processing and search time processing, or search engine processing and local computer processing. In concept following, an automated search program uses K extracted important concepts from each web page or file to perform additional web searches. These web searches are called the first level or depth one concept following. The web search results from the first level of concept following are added to the search results. The automated surfing program extracts up to K top important concepts from each web page or file in a manner similar to the extraction of important concepts for conceptual filtering, and uses the extracted important concepts as search keyword(s) to perform additional web searches. These web searches are called the second level or depth two concept following. The above process is repeated for each web page or file in the search results using the original search keyword(s), for D levels or depth D, for each web page or file in the concept following results, or until a total number of important concepts have been followed, until a user stops the process. D is a positive integer and can be set by default or by a user.

In one embodiment, an automated search program uses the same ranking as in extraction of important concepts for conceptual filtering and CPM in the selection of up to K important concepts for concepts following. The keyword(s) or phrases describing these important concepts are used as search keyword(s) in the searches of the concept following process. In another embodiment, group C and the lowest occurring words and phrases in group E are ranked higher because they present a higher probability of expanding the original search to results related to the original search keyword(s) but not in the same conceptual scope of the original search keyword(s). Concept following can be a powerful automated surfing method, For example, assume that a user wants to investigate the technologies and products for wireless network security using the original search keywords (wireless network security). The search results may contain concepts or keywords (802.11i), (WPA), (WAPI), (network access control), (802.1X), (public key encryption), names of established and startup companies. Using a prior art search engine, a user would need to manually read and click the links to see if there is anything of interest, likely wasting a lot time, and often loses track what paths have or have not been followed. More importantly, some potentially very useful paths may not be followed at all. This invention will be able to automatically follow the links based on important concepts, present the much expanded search results to a user which can be filtered, re-ranked and visualized using the filtering, ranking and CPM embodiments of this invention. This invention can be more effective even than technologies based on knowledge base and domain ontologies because web search results can quickly include new developments and current events, while it can take quite some time for a knowledge base or domain ontology to be updated. In the above wireless network security example, web search results can quickly include a startup company with a new product, a new regulation by a government agency, or new development by an industry standard body, etc. These would not be included in knowledge bases or domain ontologies until much later.

In another embodiment, rules for extraction and ranking of important concepts and Relevancy Rank that require knowing the search keyword(s) are omitted in concept following. The search results from following each important concept at level-k of concept following is considered as one level-k pool of search results. The search results and the extracted concepts in each level-k pool are ranked within the pool, in this case, omitting extraction and ranking of important concepts and Relevancy Rank that require knowledge of the search keyword(s). Then the level-k pools of search results and extracted concepts are assembled together, and a final rank for each web page or file, or important concept in this assembly of all search results is computed. The final rank of a web page or file, or important concept in a level-k pool from following an important concept may be computed as
Final Rank=(Rank of the important concept that produced the pool)*(Rank of the web page or file, or important concept within the pool).
For a web page in the second level concept following, this formula will mean that the ranking of all important concepts in this concept following path will be chained together:
Final Rank=(Rank of a first important concept in the search results of the original search)*(Rank of a second important concept within the search results retrieved using the first important concept as search keyword(s))*(Rank of the web page or file, or important concept within the search results that are retrieved by using the second important concept as search keyword(s)).
The final rank is used for selecting important concepts to following in the next level of link following, and for selecting important concepts to include in the List of Important Concepts in 412 or 612 etc.

In yet another embodiment, a first important concept that is used for as a first search keyword(s) in concept following is used as the search keyword(s) in extracting and ranking important concepts that are dependent on search keyword(s) in the pool of search results retrieved from using the first search keyword(s). The final rank for each web page or file, or important concept in the assembly of all search results can be computed in the same manner as above, except the within pool rank is computed with the use of the first search keyword(s) in extracting and ranking important concepts.

In link following, the automated search program retrieves a first set of web pages and files linked by K important links extracted from a web page or file in the search results using the original search keyword(s), and adds the first set of web pages and files, and their summaries if so desired, to the web search results. This is called the first level link following or depth one link following. The automated search program then extracts up to K important links from the first set of web pages and files, retrieves a second set of web pages and files linked by the important links extracted from a web page or file in the first set of web pages and files. It adds the second set of web pages and files, and their summaries if so desired, to the web search results. This is called the second level link following or depth one link following. The above process is repeated for each web page or file in the search results using the original search keyword(s), for D levels or depth D, for each web page or file in the link following results, or until a total number of important links have been followed, until a user stops the process.

In another embodiment, rules for extraction and ranking of important concepts and Relevancy Rank that require knowledge of the search keyword(s) are omitted in link following. The search results from following each important link at level-k of link following is considered as one level-k pool of search results. The search results and the extracted important links in each level-k pool are ranked within the pool, in this case, omitting extraction and ranking of important concepts, important links and Relevancy Rank that require knowledge of the search keyword(s). Then the search results and extracted important links for level-k are assembled together, and a final rank for important link in this assembly of all level-k search results is computed. The final rank of an important link in a level-k pool from following an important link equals
Final Rank=(Rank of the important link that produced the pool)*(Rank of the important link within the pool).
For a web page in the kth level of link following, this formula will mean that the ranking of all important links in this link following path will be chained together. The final rank is used to select important links to following in the next level of link following.

In order to control the amount of processing resources used by a search, in addition to the depth of concept or link following, the automated surfing program may also limits the total number of important concepts or important links to follow, for example, up to M important concepts or important links, where M is a positive integer and can be set by default or by user. This is referred to as the breadth of concept following and link following. In one embodiment, the automated surfing program first retrieves web search results using the original search keyword(s). It then extracts up to M top ranked important concepts or important links from each web page or file. This extraction may be either done for all web pages and files in the search results, or only done for P top ranked web pages and files in the search results. The set of web pages and files from which important concepts or important links are extracted is called the extraction set. In another embodiment of concept following, the automated search program pools all the important concepts extracted from each web page or file, remove duplicates and subset concepts, and re-rank the remaining important concepts in the same manner as in the selection of top N important concepts for inclusion in the List of Important Concepts. Then, the M top ranked important concepts are used as search keyword(s) to perform additional web searches. These web searches are called the first level or depth one concept following. The web search results from the first level of concept following are added to the search results. The automated surfing program then extracts up to M top important concepts from each web page or file in a manner similar to the above, pools all the important concepts extracted from each web page or file, remove duplicates and subset concepts, and re-rank the remaining important concepts in the same manner as above. Then, the M top ranked important concepts are used as search keyword(s) to perform additional web searches. These web searches are called the second level or depth two concept following. The above process is repeated for D levels or depth D.

In another embodiment of link following, the automated search program extracts up to M top ranked important links from each web page or file in the original search results. The automated surfing program pools the important links from each web page or file in the extraction set together, ranks them, and extracts up to M top ranked important links for link following. The automated search program then retrieves a first set of web pages and files linked by the above M top ranked important links, and adds the first set of web pages and files, and their summaries if so desired, to the web search results. This is called the first level link following or depth one link following. The automated search program then extracts up to M top ranked important links from each web page or file in the first set of web pages and files or a subset of this first set, each referred to as the extraction set. The automated surfing program pools the important links from each web page or file in the extraction set together, ranks them, and extracts up to M top ranked important links for link following. The automated search program then retrieves a second set of web pages and files linked by the above M top ranked important links, and their summaries if so desired, to the web search results. This is called the second level link following or depth one link following. The above process is repeated for D levels or depth D.

In one embodiment, the automated search program determines what links to follow by ranking the links in a web page or file. First, links in the main frame are collected. The ranking of a link can be determined by the ranking of the extracted important concepts that are semantically closest to the link. The rank of a link can be determined by the following process:
1. If the URL link is hyperlinked to a word string or phrase or sentence that contains an extracted important concept is given the same rank as the important concepts, otherwise,
2. If there is an important concept in the same sentence with the URL link, the link is given a rank equal to the rank of the important concept, otherwise,
3. If there is an important concept in the same paragraph with the URL link, the link is given a rank equal to 0.7 times the rank of the important concept, otherwise,
4. If there is an important concept in the same section with the URL link, the link is given a rank equal to 0.5 times the rank of the important concept, otherwise,
5. If there is an important concept in the same frame with the URL link, the link is given a rank equal to 0.3 times the rank of the important concept.

In the embodiments that extract K important links from each web page or file for link following, the K links can be distributed to the six groups of concepts, namely groups A to F using the same percentage for the extraction of important concepts for conceptual filtering. These K links are then used for following. If K<6, extracted important links associated with some of groups of important concepts can be ignored.

In embodiments that extract a total of M important links from all web pages and file at each level or depth for link following, M top ranked important links are extracted from each web page or file and added into a pool of extracted important links. Duplicate links are removed. The remained important links are ranked by the following formula:
Link Rank of link j=LR(j)=e*10*max{Na(j), (Nt−Na(j))}/Nt+f*{Σ_{All pages containing link j}PR(k)}/Na(j)
where e>0, f>0, e+f=1, Nt is the total number of web pages or files that in the extraction set, and Na(j) is the number of pages in the set of Nt that contain link j. Note that Na(j)>0 because at least one web page or file must contain the link for it to be included. Also note that the maximum of LR(j) is 10 for any link. This ranking formula ranks high both very popular links and very rare links. The M top ranked important links are then chosen for link following.

To reduce the amount of time a user needs to wait before results are available to a user, the concept following and link following processes can be progressive, meaning that the partial results are displayed to a user as the automated surfing program continue to carry out concept following and link following to the specified breadth and depth. As new concept following or link following results become available, they are added to the search results, displayed to a user. Filtering by important concepts, by other filtering features, and CPM can also be performed on partial results, and be continually updated as new results become available.

Extraction and following of important concepts and links can be carried out either in a search engine server, or in a user's local computer. The advantage of a search engine server embodiment is that most of the search results need not to be downloaded to a user's PC, and some or all of the important links and concepts can be extracted and ranked beforehand, thus, they are instantly available upon the retrieval of a web page or file in a search. The automated surfing program only downloads to a user's PC large files that are ranked high and may require excess amount of downloading time. Since concept following and link following may be dependent on the search keyword(s) a user used in the original search, some of the extraction and ranking of important concepts and important links may need to be performed at search time in the search engine server. This embodiment increases the amount of processing on the search engine server. When there are millions of users performing automated concept following and link following, it can put a very high demand on the processing resources of the search engine. The advantage of a local computer embodiment is that it takes advantage of the wide availability of broadband connection, large storages and fast processors in millions of PCs. However, it requires downloading all or a large number of search results to a user's local computer, and extraction of important concepts and important links can only be carried out at search time, thus increasing the time needed to perform the concept following and link following. A blended embodiment combines the advantages of the above two embodiments. In this embodiment, the search engine extracts and ranks some or all of the important links and important concepts beforehand for each web page and file, and saved them and some condensed contexts for the extraction and ranking to a file for each web page or file. At search time, the automated surfing program running in a user's PC downloads these files with pre-extracted important links and important concepts and their condensed contexts for each web page and file. It analyzes them based on the search keyword(s) used in the original search, computes the component in concept rank and link rank that are dependent on the search keyword(s), and carries out automated surfing by formulate searches, submit them to the search engine and retrieve the results. It only downloads web pages and files for which additional extraction and ranking of the important links and important concepts are needed.

The embodiments of extraction of concepts and other information elements, filtering of search results based on concepts or other features, concept and link following provide a new method for searching information, comprising, as shown in FIG. 16, extracting a first set of one or more information elements from a second set of one or more files or parts thereof (1602); selecting a third set of one or more of the information elements in the first set (1604); and, using the third set to obtain a fourth set of one or more files or parts thereof (1606).

In this method, the step 1602 may use one or more of the following in deciding what information elements to extract: a list of important words and/or phrases; a list of sentence patterns; a list of concepts or semantic meanings; relations of words or information element with items in some or all of these lists; position, formats and/or contexts of words or information elements; roles of words or information elements in the text; based on which rules an information element is identified; and the category an information element belongs to.

In this method, the second set used in 1602 may be the results of a first search that is defined by one or more descriptions of the first search. In this case, the step 1602 may also be performed using either one of the following: one or more search engines that generate the first set by extracting one or more information elements from the second set, making use of the relevancy of the information elements to the one or more descriptions of the first search; one or more search engines pre-extract one or more information elements from some or all of the files at the search engines before the first search, upon first search, a user's computer downloads the extracted one or more information elements contained in the second set from one or more search engines, and the user's computer decides what information elements to be included in the first set based on their relevancy to the one or more descriptions of the first search; upon the first search, a user's computer downloads from one or more search engines the results or parts thereof of the first search and generates the first set by extracting one or more information elements from the downloaded results or parts thereof of the first search.

In the case where the second set used in 1602 is the results of a first search, selecting a third set in step 1604 may be done by providing an interface to display and allow a user to select one or more information elements in the first set, and using the user's selection as the third set; and step 1606 may be implemented by submitting the selected information elements in the third set together with the one or more descriptions of the first search as the description of a second search to one or more search programs to perform the second search, and the fourth set includes files or parts thereof found from the second search. In addition, the interface above may allow a user to select one or more information elements in the first set for inclusion or exclusion, and the second search may search for files that contain the information elements selected for inclusion and do not contain the information elements selected for exclusion, and the fourth set includes files or parts thereof found from the second search.

In the above method, step 1604 may select a third set is based a ranking of the one or more information elements in the first set, e.g., by concept ranking CR. Links can be similarly ranked using the contextual information and the texts of the links.

The above method can be used for concept following, wherein the one or more information elements in the first set are concepts, selecting a third set in 1604 comprises selecting one or more concepts, and using the third set to obtain the fourth set in 1606 comprises submitting the selected concepts in the third set to one or more search programs to perform a second search for files that contain the selected concepts in the third set, and the fourth set includes files or parts thereof from the second search. The concept following can be repeated to a given depth by further extracting one or more concepts from the fourth set, and repeating the method a number of times.

The above method can be used for link following, wherein the one or more information elements in the first set are links, selecting a third set in 1604 comprises selecting one or more links, and using the third set to obtain the fourth set in 1606 comprises including in the fourth set files or parts thereof linked by the selected links in the third set. The link following can be repeated to a given depth by further extracting one or more links from the fourth set, and repeating the method a number of times.

### Tracking Sites and Tracking Searches

This invention also automates the monitoring of selected web sites or web pages, and keeping a search of a defined topic active over an extended period of time to monitor and detect changes and new information related to the defined topic.

In one embodiment, after the user interface program of this invention displays the search results conducted using a first search keyword(s), the user interface program offers an option check box for each search result “Monitor this Web Page.” When a user checks this box for a web page, the user interface program displays a small window asking the user to specify the time period over which he wants to monitor the web page, and the frequency a page/site monitoring program of this invention should checked the monitored pages for changes. Both the time period and the monitoring frequency may be chosen by a pull-down menu, or text box and check boxes. A user may specify to, e.g., monitor over a time period of 1 week, 1 month, X months, for every 2 hours, once a day, once a week, etc. A default value may be set, e.g., every day for a month. It may also offer the options for “Expand to Monitoring to All Pages in the Same Folder,” “Monitoring This Page and Pages Linked to This Page,” “Monitoring This Page and Pages that This Page Links to,” and “Expand Monitoring to the Entire Web Site,” etc. The user interface program may also offer a user to select how he wants to be informed of any changes in the web pages being monitored. For example, the small window may have an option for a user to enter an email address for the page/site monitoring program to send him an email in case changes are detected. Alternatively, it has a check box for a desktop alert. When this box is checked, the page/site monitoring program pops up an alert window in the user's computer screen to inform the user of changes in the web pages being monitored. For each web page being monitored, a page/site monitoring program computes and stores a checksum or digital digest, e.g., CRC32, MD5, SHA-1, for each of the pages to be monitored. Then at the specified interval, a control program triggers the page/site monitoring program, which then retrieves the web pages being monitored, re-calculates the same checksum or digital digest for each web page and compare it with the stored checksum or digital digest. If the page/site monitoring program detects a difference in the stored and newly computed checksum or digital digest, it sends an alert or email to the user who set the monitoring to inform him of the changes. The page/site monitoring program stores the new checksum or digital digest. If there is no difference, the page/site monitoring program does nothing. The same process is repeated when the page/site monitoring program is triggered at the end of the next scheduled interval, until the end of the monitoring period is reached. The page/site monitoring program can also ask the user whether he wants to extend the monitoring period.

In another embodiment, the page/site monitoring program also allows a user to enter web sites or web pages to be monitored into a list. This way, this invention can monitor web pages and sites for a user without the user conducting a search. Similar user interface can be provided for a user to choose the monitoring period, frequency, expansion of the monitoring pages, as described above.

In one embodiment, before a user conducts a search using a second search keyword(s), he may choose to keep the search active by specifying the start and end date in 110 or 312. Such a search is called a sustained search. If no start date is given, it is assumed to be the day the search is first conducted. Alternatively, the interface may allow a user to specify the time period to be X weeks, or X months, etc. In yet another embodiment, the user interface program offers a “Keep Search Active” button in the toolbar or an item in the Options. After the user interface program of this invention displays the search results conducted using a second search keyword(s), a user may click the “Keep Search Active” toolbar button or click the “Keep Search Active” option in the Options menu. In that case, the user interface program displays a window with an option “Keep This Search Active for X Days/Weeks/Months.” The user enters a number in the box and selects Days, or Weeks or Months in a pull-down menu. In both the above two embodiments, a sustained search program computes and stores a checksum or digital digest, e.g., CRC32, MD5, SHA-1, for each of the pages in the list of search results returned by a search engine. Then at the specified interval, a control program triggers the sustained search program, which then submits the second keyword(s), to a search engine to conduct a search using the second keyword(s). The sustained search program retrieves the new list of search results returned by the search engine. It re-calculates the same checksum or digital digest for each page of the new list of search results and compares it with the stored checksum or digital digest. If the sustained search program detects a difference in the stored and newly computed checksum or digital digest, it sends an alert or email to the user to inform him of the changes. The sustained search program stores the new checksum or digital digest. If there is no difference, the sustained search program does nothing. The same process is repeated when the sustained search program is triggered at the end of the next scheduled interval, until the end of the sustained search period is reached. The sustained search program can also ask a user whether to extend the sustained search period. This embodiment can detect new web pages or files in the list of search results, as well as changes in ranks of web pages or files in the listing. In another embodiment, the sustained search program saves the lists of search results and compares the lists at each triggering. Thus, it can detect new web pages and files, distinguish addition of new web pages or files from a change in ranks of previously searched web pages and files.

In yet another embodiment, a sustained search program saves the pages in the list of search results, computes and stores a checksum or digital digest for each web page or file listed in the search results. At each triggering of the sustained search program, it compares both the lists of search results and checksum or digital digest for each web page or file that is present in both the previous search and the current search. This way, the sustained search program not only detects addition or removal of information sources, but also detects changes in the web pages and files themselves. This effectively combines sustained search and web page monitoring described previously. The web page monitoring is applied to all web pages and files in the search results. Such processing may require a lot of computing resources and take some time.

In one embodiment, the sustained search program in any of the above embodiments can be made into a progressive process, meaning that partial results are sent to the user when changes are found after a certain percentage of the pages in the list of search results, or web pages and files in the search results, are processed. In another embodiment, to limit the amount of processing, the sustained search program is only applied to the first X pages of the list of search results, or the first X web pages and files in the search results.

In all the embodiments above, the page/site monitoring program and the sustained search program can be implemented either at a search engine, or at a user's local PC, or at both with each carrying out part of the tasks. If it is implemented on a user's local PC, the page/site monitoring program and the sustained search program will call the download program to download the web pages and files in the search results when needed. It is not necessary to save all the downloaded web pages and files. The page/site monitoring program and the sustained search program only needs to compute and save the checksums or digital digests for each page or file as needed. The sustained search program may also need to compute and save the checksum or digital digest of the pages in the list of search results returned by a search engine.

The embodiments of sustained search and page/site and file monitoring provide a new method for information monitoring, comprising, as shown in FIG. 20, providing an option in a browsing application window for monitoring changes in the content of a URL or in the results of a search that is being accessed in the window (2002); when a user selects the option, checking for changes in the content of the URL or in the results of the search over a period of time (2004); and, alerting the user of the change if a change is detected (2004). This method may further provide an option for a user to specify a period of time or the frequency to perform the information monitoring.

In this method, step 2004 may be performed using a user's computer. Step 2004 may also be achieved by visiting the URL repeatedly over a period of time at a certain frequency, and finding changes in the contents at the URL, or by performing the same search repeatedly over a period of time at a certain frequency, and finding changes in the search results. As a of checking for changes, step 2004 may compute and store a checksum or digital digest of the contents at a URL or of the list of the search results at a first time, and comparing the stored checksum or digital digest with the one that is computed at a later time from the contents at the same URL or from the list of the search results by performing the same search.

### Split Meta Search

In one embodiment, to keep a user's search private, a split search program of this invention is installed in the user's local computer. The split search program breaks a string of search keywords into two ore more subsets, and sends each subset to a different search engine. Since each search engine uses a subset of the search keywords, its search results comprise a superset of the search results that would be found if the search were conducted using the complete string of search keywords. The split search program then retrieves or downloads the search results from each of the search engine, and performs a search of the combined search results using the complete string of search keywords on his local computer. This is equivalent to finding the intersection of the search results from each search engine. In this way, the complete search keyword string a user used for the search is not exposed to any single search engine, thus, maintaining the privacy of the user's search. For example, it avoids a search engine or someone monitoring the searches conducted by users from guessing a user's creative intentions.

In one embodiment, the user interface program offers a “Split Search” button in the toolbar or an item in the “Options” menu “Split keywords to multiple search engines,” which will be shown when a user clicks the “Options” button. A user can choose the option by clicking the corresponding button or check box. The split search program then randomly splits the search keywords into subsets and selects a search engine to send each subset. In another embodiment, the user interface program also allows a user to determine how many subsets the search words are to be broken into, what search engines are to be used, or which subset of the search keywords is to be sent to which search engine.

### Overall System

In one embodiment, the programs of this invention are modularized to maximize language independency with well-defined language module plug-ins for different languages. The language-independent modules form the core system. Language adaptation modules, language specific modules, and language specific knowledge base can be interfaced with the core system to provide the functions of this invention with specific language user interfaces, e.g., English, French, Chinese, etc.

In one embodiment, there is an advertising module that sends the search keyword(s) and user selected concepts to a first server. The advertising module accepts instructions from the first server to rank higher those pages that match criteria provided by the server, and accepts advertisement information from the first server and displays the advertisement in places in the web browser window as specified by the server.

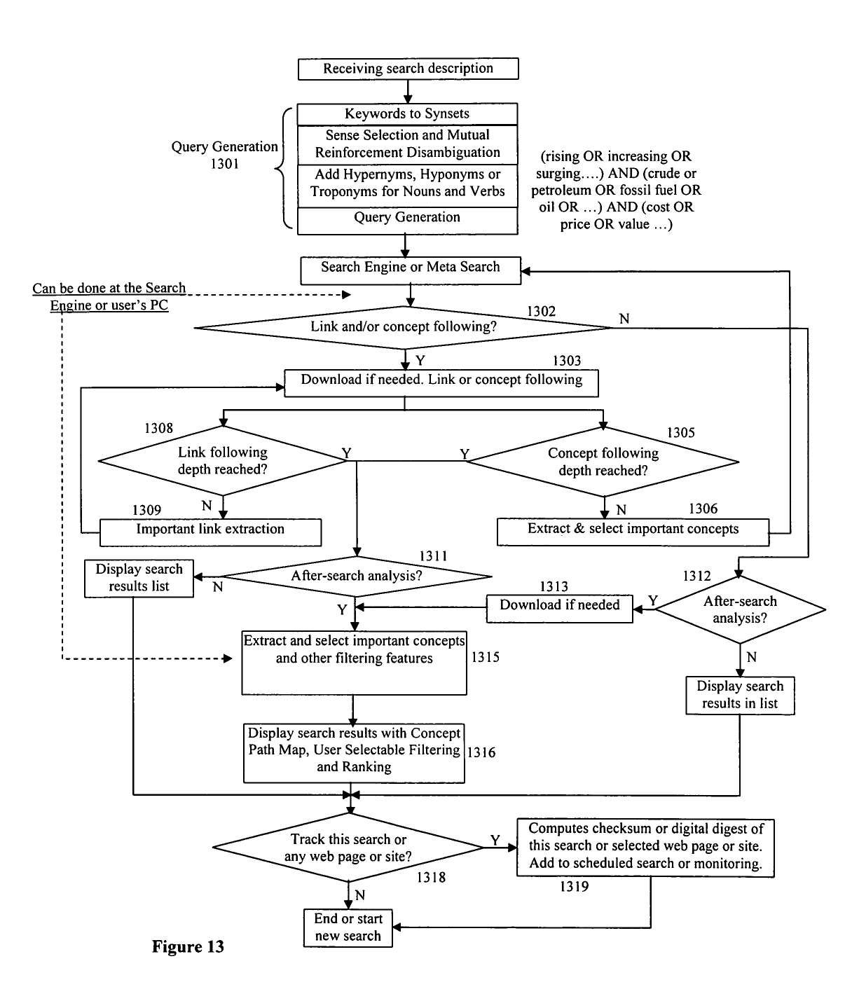

FIG. 13 shows a high level flowchart of some of the embodiments of this invention for a web search. This flowchart integrates query generation 1301, concept following (1302, 1303, 1305) link following (1302, 1308, 1309), extraction, ranking, selection and listing of important concepts and other filtering features, filtering by such important concepts and other filtering features, and generation and display of CPMs (1311, 1312, 1313, 1315 and 1316, collectively referred to as “After search analysis” in FIG. 13), and monitoring for information changes in a search or web site or page (1318 and 1319). As previously discussed, the tasks between the two dash arrows can be implemented either in a search engine server or in a user's local computer, or parts of them can be implemented in each.

Although the foregoing descriptions of the preferred embodiments of the present invention have shown, described, or illustrated the fundamental novel features or principles of the invention, it will be understood that various omissions, substitutions, and changes in the form of the detail of the methods, elements or apparatuses as illustrated, as well as the uses thereof, may be made by those skilled in the art without departing from the spirit of the present invention. Hence, the scope of the present invention should not be limited to the foregoing descriptions. Rather, the principles of the invention may be applied to a wide range of methods, systems, and apparatuses, to achieve the advantages described herein and to achieve other advantages or to satisfy other objectives as well. Thus, the scope of this invention should be defined by the claims to be filed in the regular patent application of this invention.

I claim:

1. A method to generate a search query using a description provided by a user comprising extracting a first set of one or more words or phrases or sentences from the description;
expanding the first set by generating a second set of one or more words or phrases or sentences that are conceptually related to one or more words or phrases or sentences in the first set; and,
submitting the second set as the description of a search to a first search program to perform a search for files containing some or all of the words or phrases or sentences in the second set.

2. The method of claim 1, wherein expanding the first set comprises using one or more knowledge base for generating the second set.

3. The method of claim 1, wherein expanding the first set comprises using one or more search results that are obtained by using the one or more words or phrases or sentences in the first set for generating the second set.

4. The method of claim 1, wherein when the first set contains two or more words or phrases or sentences, expanding the first set comprises including in the second set the first set, the synsets of the one or more senses of a word or phrase or sentence in the first set that receives reinforcement from one or more senses of one or more other words or phrases or sentences in the first set.

5. The method of claim 1, wherein the first search program searches for information over a network.

6. The method of claim 1, wherein the first search program searches for information in a user's computer.

7. A method for searching information comprising
providing an interface to accept from a user a first description and a second description that define a search;
searching for one or more files or similar information containing objects that contain some or all of the information in the first description, and contain none or some or all of the information in the second description.

8. The method in claim 7, wherein the first description is one or more keywords, and the second description is one or more keywords.

9. The method in claim 7, further comprising ranking higher a file or an information containing object that contains more of the information in the second description.

10. A method for searching information comprising
extracting a first set of one or more information elements from a second set of one or more files or parts thereof;
selecting a third set of one or more of the information elements in the first set; and,
using the third set to obtain a fourth set of one or more files or parts thereof.

11. The method of claim 10, wherein extracting the first set comprises using one or more of the following in deciding what information elements to extract: a list of important words and/or phrases; a list of sentence patterns; a list of concepts or semantic meanings; relations of words or information element with items in some or all of these lists; position, formats and/or contexts of words or information elements; roles of words or information elements in the text; based on which rules an information element is identified; and the category an information element belongs to.

12. The method of claim 10, wherein the second set is the results of a first search that is defined by one or more descriptions of the first search.

13. The method of claim 12, wherein extracting the first set is performed using either one of the following: one or more search engines that generate the first set by extracting one or more information elements from the second set, making use of the relevancy of the information elements to the one or more descriptions of the first search; one or more search engines pre-extract one or more information elements from some or all of the files at the search engines before the first search, upon first search, a user's computer downloads the extracted one or more information elements contained in the second set from one or more search engines, and the user's computer decides what information elements to be included in the first set based on their relevancy to the one or more descriptions of the first search; upon the first search, a user's computer downloads from one or more search engines the results or parts thereof of the first search and generates the first set by extracting one or more information elements from the downloaded results or parts thereof of the first search.

14. The method of claim 12, wherein selecting a third set comprises providing an interface to display and allow a user to select one or more information elements in the first set, and using the user's selection as the third set; and wherein using the third set to obtain a fourth set comprises submitting the selected information elements together with the one or more descriptions of the first search as the description of a second search to one or more search programs to perform the second search, and the fourth set includes files or parts thereof found from the second search.

15. The method of claim 12, wherein selecting a third set comprises providing an interface to display and allow a user to select one or more information elements in the first set for inclusion or exclusion, and using the user's selection as the third set; and wherein using the third set to obtain a fourth set comprises submitting the selected information elements together with the one or more descriptions of the first search as the description of a second search to one or more search programs to perform a second search for files that contain the information elements selected for inclusion and do not contain the information elements selected for exclusion, and the fourth set includes files or parts thereof found from the second search.

16. The method of claim of 10, wherein selecting a third set is based a ranking of the one or more information elements in the first set.

17. The method of claim of 10, wherein the one or more information elements in the first set are concepts, selecting a third set comprises selecting one or more concepts, and using the third set to obtain the fourth set comprises submitting the selected concepts in the third set to one or more search programs to perform a second search for files that contain the selected concepts in the third set, and the fourth set includes files or parts thereof from the second search.

18. The method of claim 17, further comprising extracting one or more concepts from the fourth set, and repeating the method a number of times.

19. The method of claim of 10, wherein the one or more information elements in the first set are links, selecting a third set comprises selecting one or more links, and using the third set to obtain the fourth set comprises including in the fourth set files or parts thereof linked by the selected links in the third set.

20. The method of claim 19, further comprising extracting one or more links from the fourth set, and repeating the method a number of times.
